(19) United States
(12) Patent Application Publication
(10) Pub. No.: US 2011/0200978 A1
(43) Pub. Date: Aug. 18, 2011

(54) ONLINE INSTRUCTIONAL DIALOG BOOKS

(75) Inventors: John Robert Bergan, Tucson, AZ (US); Michael Rattee, Tucson, AZ (US)

(73) Assignee: ASSESSMENT TECHNOLOGY INCORPORATED, Tucson, AZ (US)

(21) Appl. No.: 13/028,831

(22) Filed: Feb. 16, 2011

Related U.S. Application Data
(60) Provisional application No. 61/282,469, filed on Feb. 16, 2010.

(51) Int. Cl. G09B 7/00

(52) U.S. Cl. 434/322

(57) ABSTRACT

A computer implemented instructional management system enables educators to organize and integrate Internet-based or other digital content with planning, assessment, and intervention information. Interactive instructional dialog files, or simply “dialogs,” offer a flexible alternative to traditional printed textbooks in the education environment. Dialogs are assembled into a larger electronic, interactive instructional content presentation, or “Dialog Book.” Thus dialog books are comprised of instructional resource content comprising individual instructional dialogs aligned to standards for inclusion in a book chapter; and links to websites, and various other digital media content. Flexible online creation and editing of dialog books supports dynamically (a) Aligning instructional materials directly to pacing calendars; (b) Adapting instructional materials to accommodate changing educational standards and advances in knowledge within the educational materials; (c) Constructing intervention portfolios that document intervention implementation and outcomes; and other benefits. These resources can be shared electronically across classrooms, teachers, districts and even states.

### RELATED APPLICATIONS

This application is a non-provisional of U.S. Provisional Application No. 61/282,469 filed Feb. 16, 2010 and incorporated herein by this reference. This application also is related to U.S. Pat. Nos. 6,322,366, 6,468,085 and 7,065,516 and U.S. patent application Ser. Nos. 11/009,708; 12/222,384; 12/222,385; and 12/230,802 all of which patents and application are expressly incorporated in their entirety herein. Additionally the disclosure in U.S. Published Patent Application 2003/0044762 is expressly incorporated in its entirety herein.

Copyright 2010-2011 Assessment Technology, Inc. (ATI). A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to methods and apparatus for interactive electronic instruction.

### BACKGROUND OF THE INVENTION

The ability to provide online instructional content including text, images, animations, audio presentations, and movies is increasing rapidly as Internet technology advances. Online instructional content is now being offered in a number of ways: Online independent learning activities including animations are available for students on many websites. Short online movies are available as supplementary instructional resources, and online textbooks are now being provided to accompany traditional printed materials.

The many online content innovations that have emerged in recent years are welcome additions to the arsenal of instructional tools available to schools. At the same time, utilization of these additions poses challenges to educators facing the task of aligning instruction to state standards and the need to elevate student achievement to new levels. In order to accommodate the multiple types of standards that exist across states and the frequent changes in standards to which districts must adjust instruction, there is a need for flexible approaches to the organization and scheduling of instructional material. In addition, there is a need to link instruction directly to instructional outcomes in ways that ensure that interventions promoting the mastery of instructional material will lead directly to the mastery of standards as measured by performance on statewide assessments.

### SUMMARY OF THE INVENTION

This patent application forges new ground in the online content area by providing Online Instructional Dialog Book technology that enables schools to organize online content and to integrate content with planning, assessment, and intervention information in ways that support effective data driven instruction.

Note that we use the term “online” herein and in the claims broadly without limitation to any particular wired or wireless network. For example, while some aspects of the present invention may be used via the Internet, other aspects may be used inside a school building over a local (wired or wireless) network. Moreover, some aspects may be used in a classroom or other group setting simply by short-range wired or wireless connectivity without a formal network.

Dialogs can be linked together to form virtual textbooks using the Dialog Book Builder feature. Virtual texts provide a cost effective alternative to printed texts. In addition, they offer the flexibility needed to align instructional materials directly to district pacing calendars and to adapt instructional materials to accommodate changing educational standards and rapid advances in knowledge characteristic of the global society in which we live. Instructional material can be added, modified, or deleted on a continuous basis (FIG. 5). Thus, there is never a need to purchase a second edition. The Book Builder feature can also be used to construct intervention portfolios that document intervention implementation and intervention outcomes.

The application builds upon a prior application that presented online instructional dialogs (Ser. No. 12/230,802). An online instructional dialog is a series of online communications among students and their teacher. Communications may include the presentation of a lesson, discussion of the lesson, and assessments of the mastery of lesson objectives. The Instructional Dialog feature in Galileo K-12 online supports the construction and implementation of instructional dialogs between teachers and their students aimed at promoting the mastery of educational standards. ATI dialog technology makes it possible for users (e.g. teachers) to ask questions aligned to state standards and to monitor student responses to those questions electronically. Dialog technology also supports student communications and provides teachers with the capability to respond to student questions electronically. Teacher questions can be in the form of tests composed of items aligned to standards. Teacher questions may also take the form of informal notes posed in real-time or test questions entered into the system in real-time during a student-teacher dialog. Student-initiated communications take the form of informal notes, which may cover a range of topics. For example, a student may ask for help with a problem or express a perspective on the problem.

In one embodiment, a computer-implemented method is provided for building an electronic, interactive instructional content presentation, or dialog book, the method comprising the steps of: selecting at least one educational resource in the form of a digital file; importing the selected educational resources into the instructional content presentation; organizing the imported educational resources in the instructional content presentation into a hierarchical structure for use by educators, the structure including chapters; and aligning collections within the hierarchical structure to predetermined educational standards.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a legend illustrating the functions of various symbols used in the flow chart diagrams of the following figures.

FIG. 2 is a flow diagram of a computer program implementation of “Online Instructional Dialog Books.”

FIG. 3 is a screen display illustrating the log in page for “Galileo K-12 Online.” operation.

FIG. 4 is a screen display illustrating a “Settings Page” operation.

FIG. 5 is a flow diagram of a computer program implementation of a “Dialog Book Builder” function.

FIG. 6 is a screen display illustrating a “Enter Dialog Book Builder” operation.

FIG. 7 is a screen display illustrating a “Dialog Book Builder Main Page” operation.

FIG. 8 is a flow diagram of a computer program implementation of a “View Existing Dialog Book” function.

FIG. 9 is a screen display illustrating a “Dialog Book View Entry” operation.

FIG. 10 is a screen display illustrating a “Dialog Book View” operation.

FIG. 11 is a flow diagram of a computer program implementation of a “View Existing Dialog” function.

FIG. 12 is a screen display illustrating “View Existing Dialog” operation.

FIG. 13 is a screen display illustrating “Dialog Preview” operation.

FIG. 14 is a screen display illustrating “Dialog Preview—Review Question/Feedback Screen” operation.

FIG. 15 is a screen display illustrating “Dialog Preview—Review/Exit Dialog Screen” operation.

FIG. 16 is a screen display illustrating “Dialog Preview—Rate Dialog” operation.

FIG. 17 is a flow diagram of a computer program implementation of a “Schedule Dialog Assignment” function.

FIGS. 18 and 19 are screen displays illustrating “Schedule Dialog Assignment” operation.

FIG. 20 is a flow diagram of a computer program implementation of a “Copy Existing Dialog Book” function.

FIGS. 21 and 22 are screen displays illustrating “Copy Existing Dialog Book” operation.

FIG. 23 is a flow diagram of a computer program implementation of an “Edit Existing Dialog Book” function.

FIG. 24 is a screen display illustrating “Edit Existing Dialog Book” operation.

FIG. 25 is a screen display illustrating “Edit Existing Dialog Book—Book Setup” operation.

FIGS. 26 and 27 are screen displays illustrating “Edit Existing Dialog Book—Chapter Objectives” operation.

FIG. 28 is a flow diagram of a computer program implementation of an “Edit Existing Dialog Book—Chapter Dialogs” function.

FIG. 29 is a screen display illustrating “Edit Existing Dialog Book—Go to Chapter Dialogs” operation.

FIG. 30 is a screen display illustrating “Edit Existing Dialog Book—Go to View PO Dialogs” operation.

FIG. 31 is a screen display illustrating “Edit Existing Dialog Book—Add Dialog to Book” operation.

FIG. 32 is a screen display illustrating “Edit Existing Dialog Book—Go to View Chapter PO Dialogs” operation.

FIG. 33 is a flow diagram of a computer program implementation of an “Edit Existing Dialog Book—Chapter Resources” function.

FIG. 34 is a screen display illustrating “Edit Existing Dialog Book—Go to View Chapter Resources” operation.

FIG. 35 is a screen display illustrating “Edit Existing Dialog Book—Chapter Resources” operation.

FIG. 36 is a screen display illustrating “Edit Existing Dialog Book—Add Chapter Resources” operation.

FIG. 37 is a screen display illustrating “Edit Existing Dialog Book—Reorder Chapter Resources” operation.

FIG. 38 is a flow diagram of a computer program implementation of an “Edit Existing Dialog Book—Reorder Chapter Content” function.

FIG. 39 is a screen display illustrating “Edit Existing Dialog Book—Go to Reorder Chapter Content” operation.

FIG. 40 is a screen display illustrating “Edit Existing Dialog Book—Reorder Chapter Content” operation.

FIG. 41 is a flow diagram of a computer program implementation of an “Edit Existing Dialog Book—Add Resource Section” function.

FIG. 42 is a screen display illustrating “Edit Existing Dialog Book—Go to Add Resource Section” operation.

FIG. 43 is a screen display illustrating “Edit Existing Dialog Book—Add Resource Section” operation.

FIG. 44 is a flow diagram of a computer program implementation of an “Edit Existing Dialog Book—Edit Resource Section” function.

FIG. 45 is a screen display illustrating “Edit Existing Dialog Book—Go to Edit Resource Section” operation.

FIG. 46 is a screen display illustrating “Edit Existing Dialog Book—Edit Resource Section” operation.

FIG. 47 is a flow diagram of a computer program implementation of an “Edit Existing Dialog Book—Book Status” function.

FIG. 48 is a screen display illustrating “Edit Existing Dialog Book—Go to Change Book Status” operation.

FIG. 49 is a screen display illustrating “Edit Existing Dialog Book—Change Book Status” operation.

FIG. 50 is a flow diagram of a computer program implementation of an “Add Dialog Book—Create Dialog Book” function.

FIG. 51 is a screen display illustrating “Add Dialog Book—Go to Create Dialog Book” operation.

FIG. 52 is a screen display illustrating “Add Dialog Book—Create Dialog Book” operation.

FIG. 53 is a screen display illustrating “Add Dialog Book—Reorder Chapters” operation.

FIG. 54 is a flow diagram of a computer program implementation of an “Intervention Alert Report” function.

FIG. 55 is a screen display illustrating “Intervention Alert Report—Go to Report” operation.

FIG. 56 is a screen display illustrating “Intervention Alert Report—Settings Page” operation.

FIG. 57 is a screen display illustrating “Intervention Alert Report—Results Page” operation.

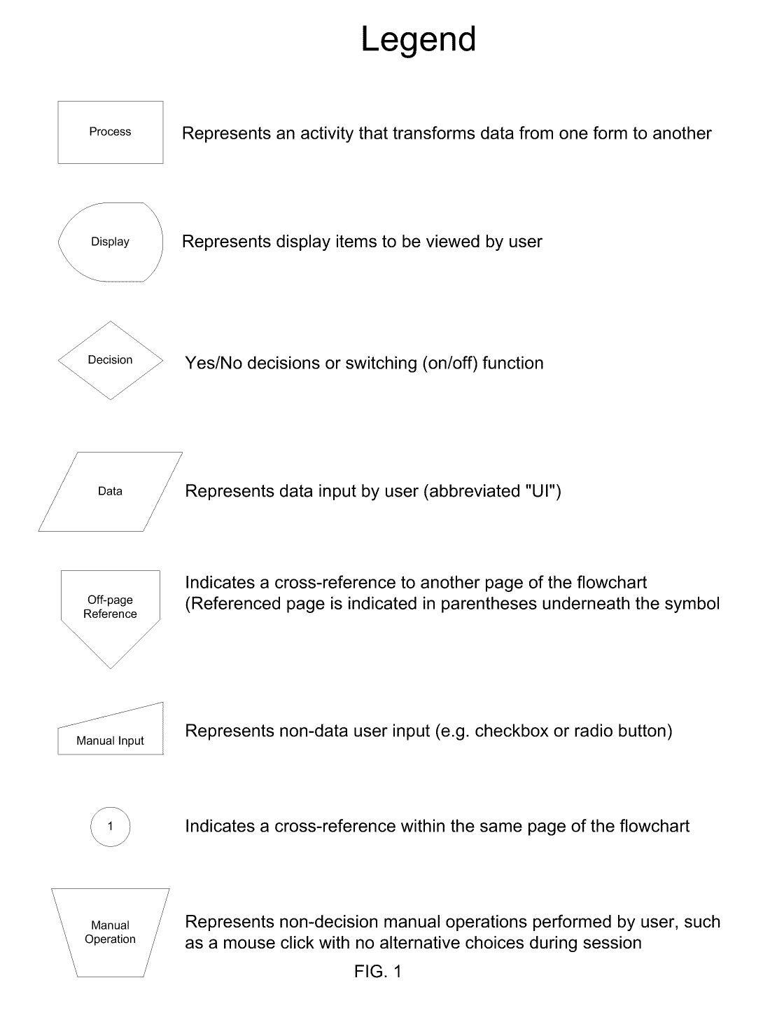

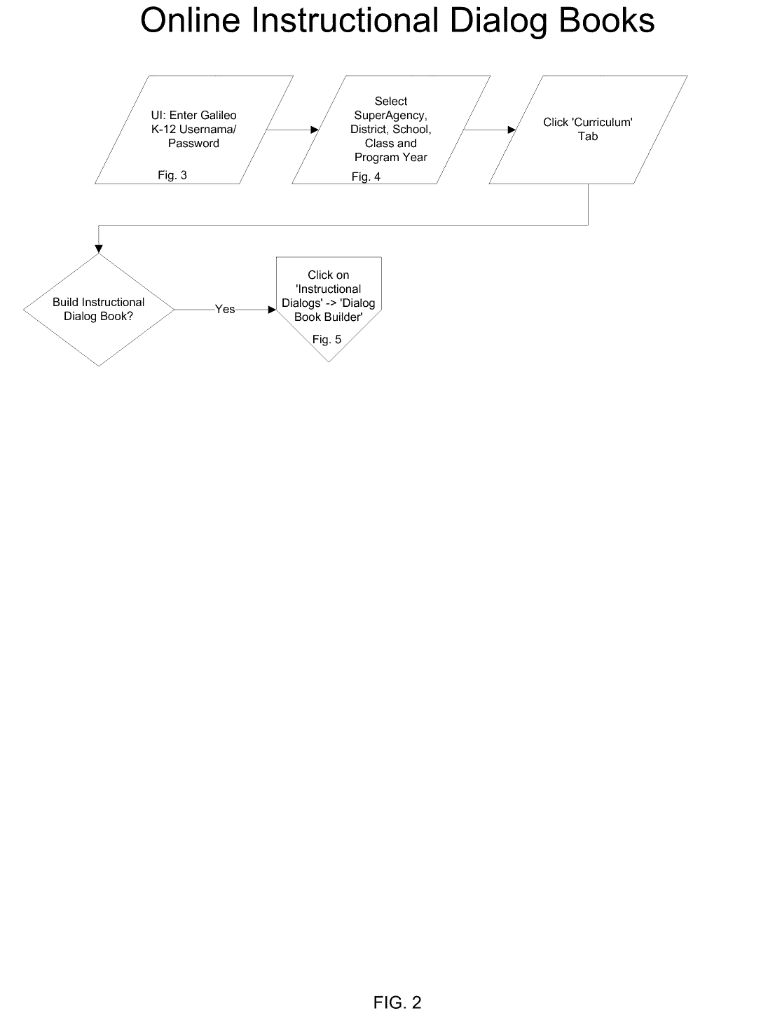

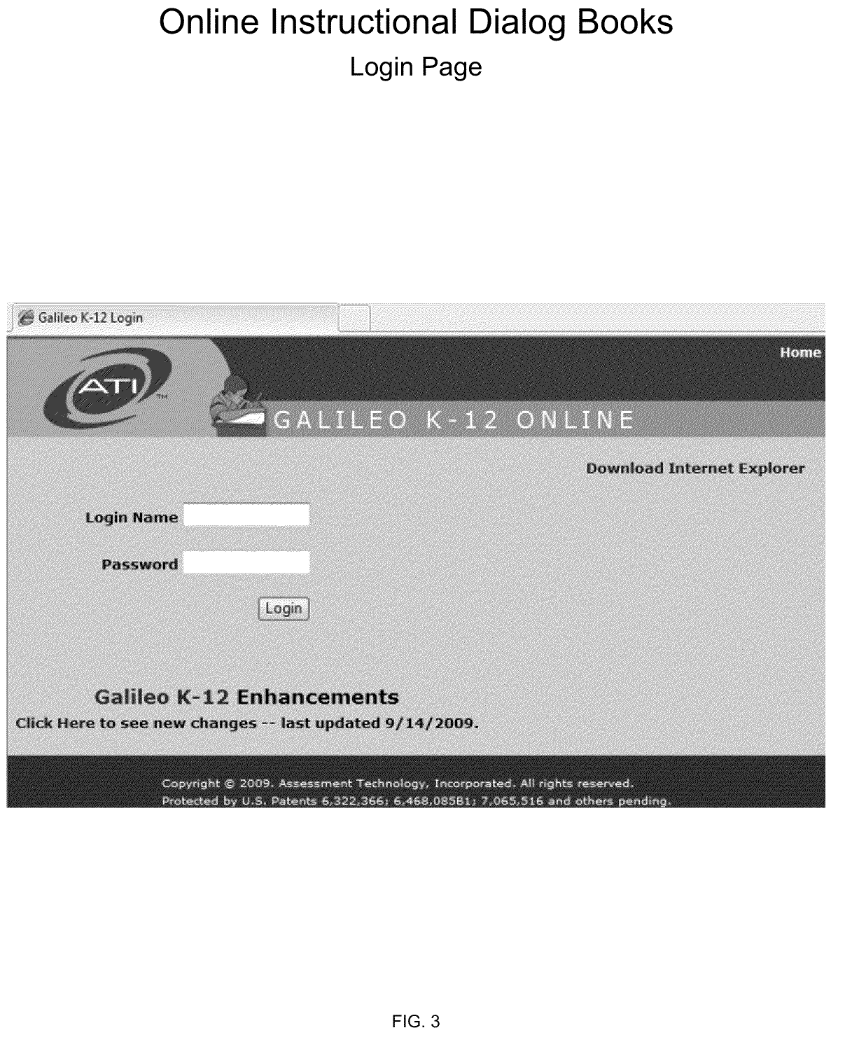

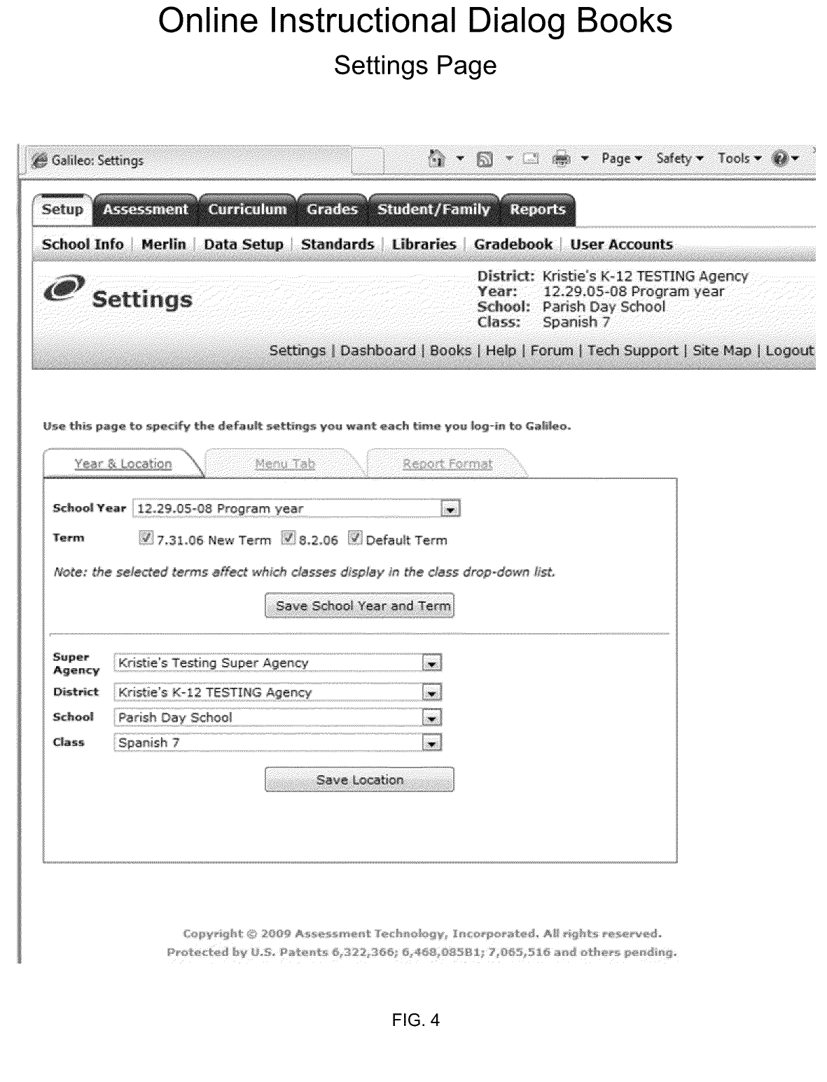

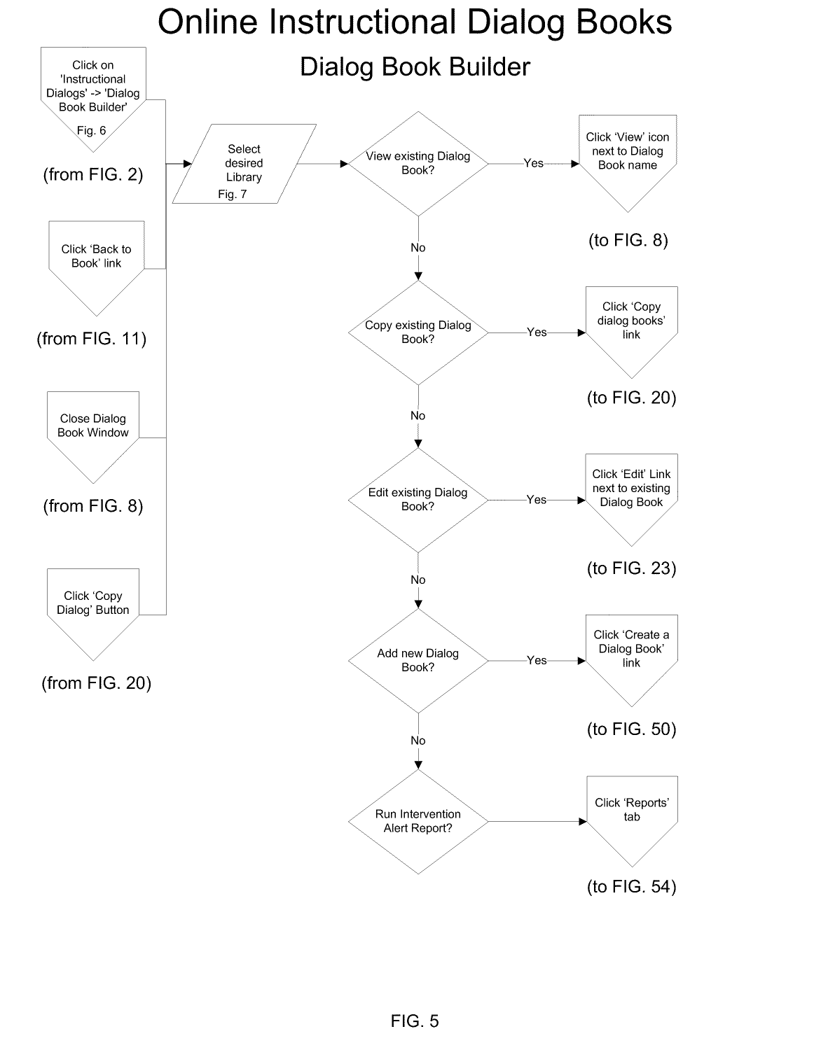

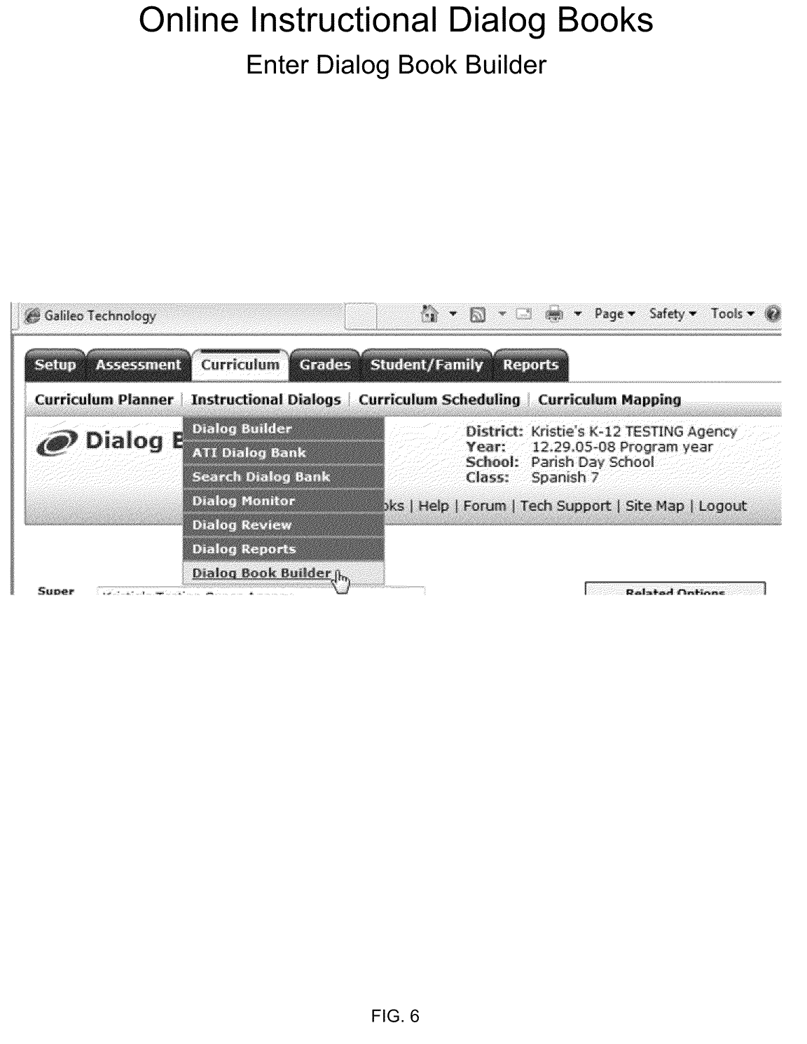

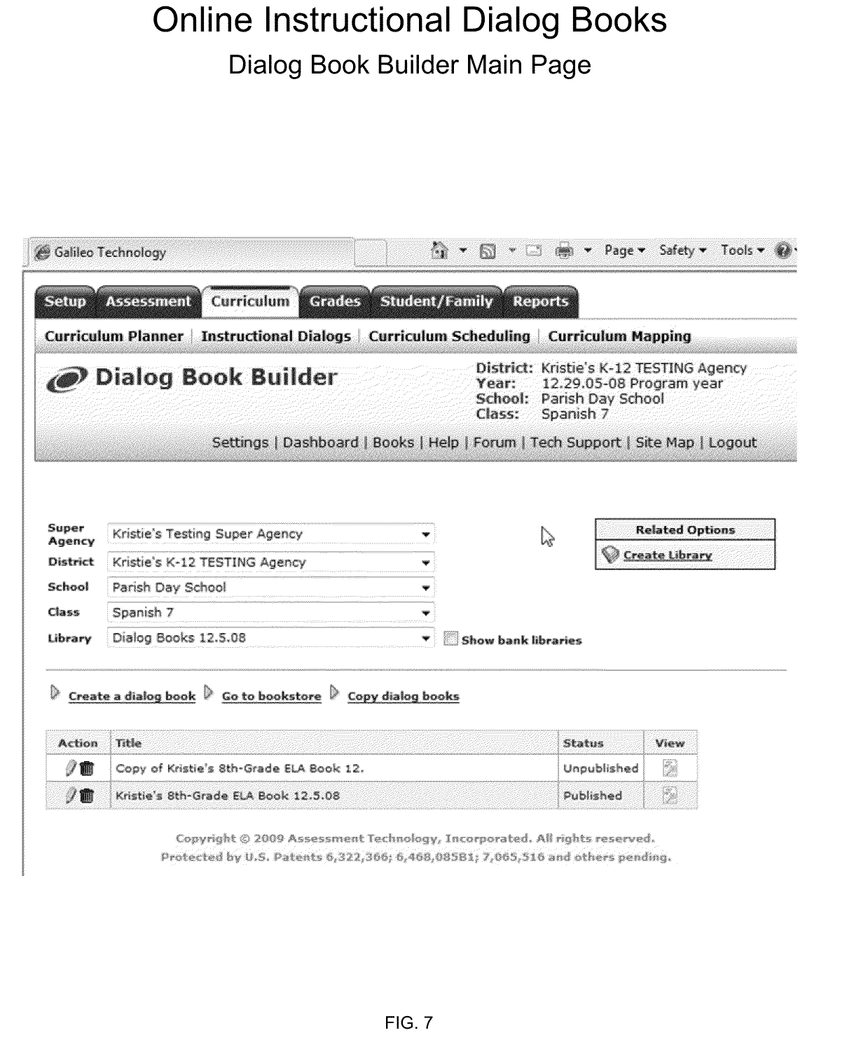

### DETAILED DESCRIPTION OF PREFERRED EMBODIMENTS

A dialog monitoring feature in Galileo Online makes it possible to monitor student responses to dialog questions in real time. The dialog monitoring tool provides information on the responses of each student to questions. In addition, the tool provides aggregated information indicating the extent to which the group participating in the dialog has responded correctly to questions.

The questions in a dialog are mapped to specifications which are aligned to standards in multiple states. This makes it possible to automatically align dialogs to standards in a given state as soon as the dialog is selected for use in that state.

Student responses to dialog questions can be immediately aggregated across classes, schools, and districts. The ability to aggregate responses to dialogs provides information that can be used by school- and district-level administrators to manage instruction.

### Dialog Book Builder

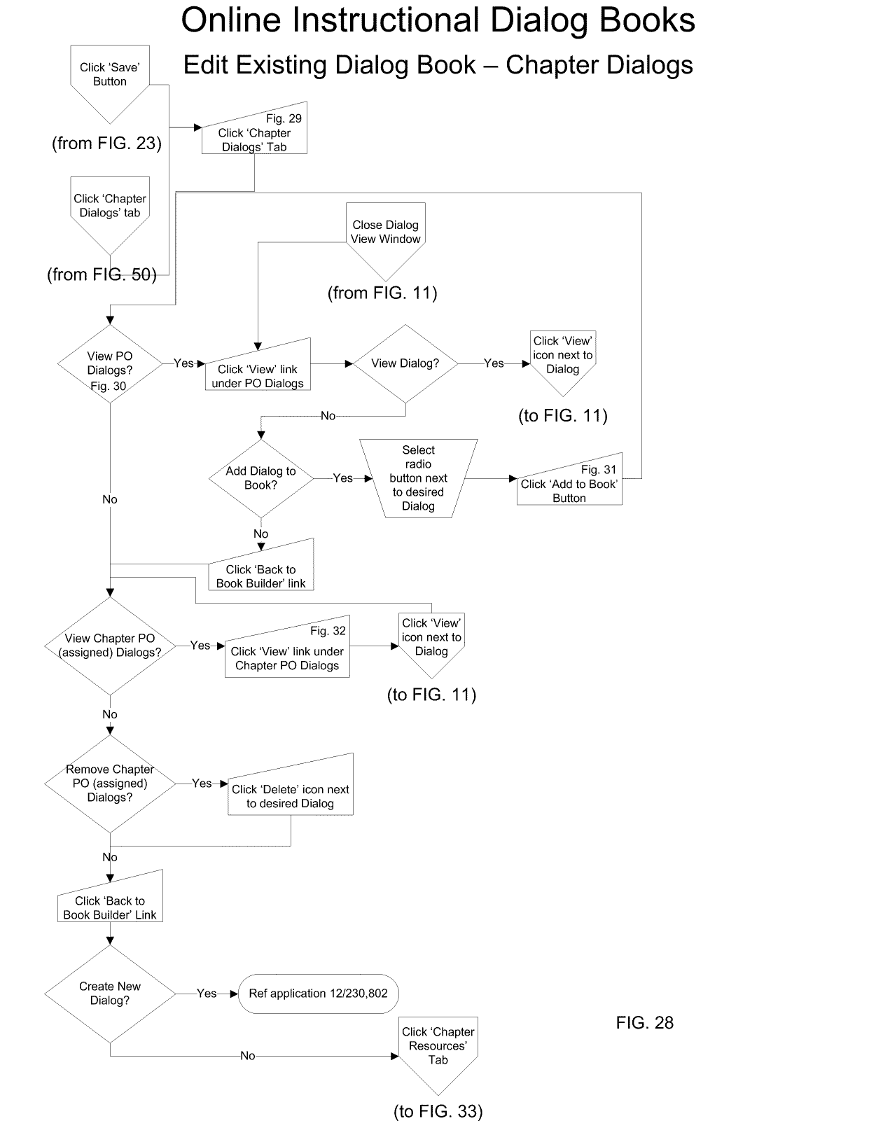

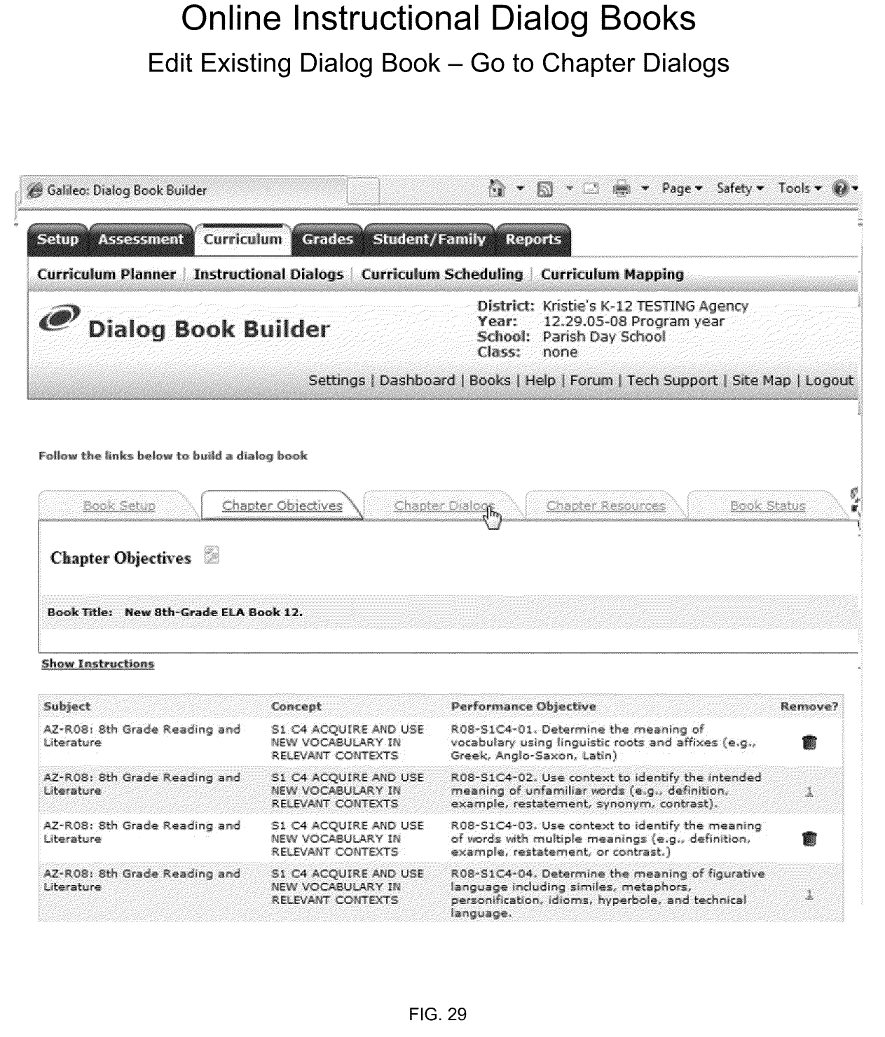

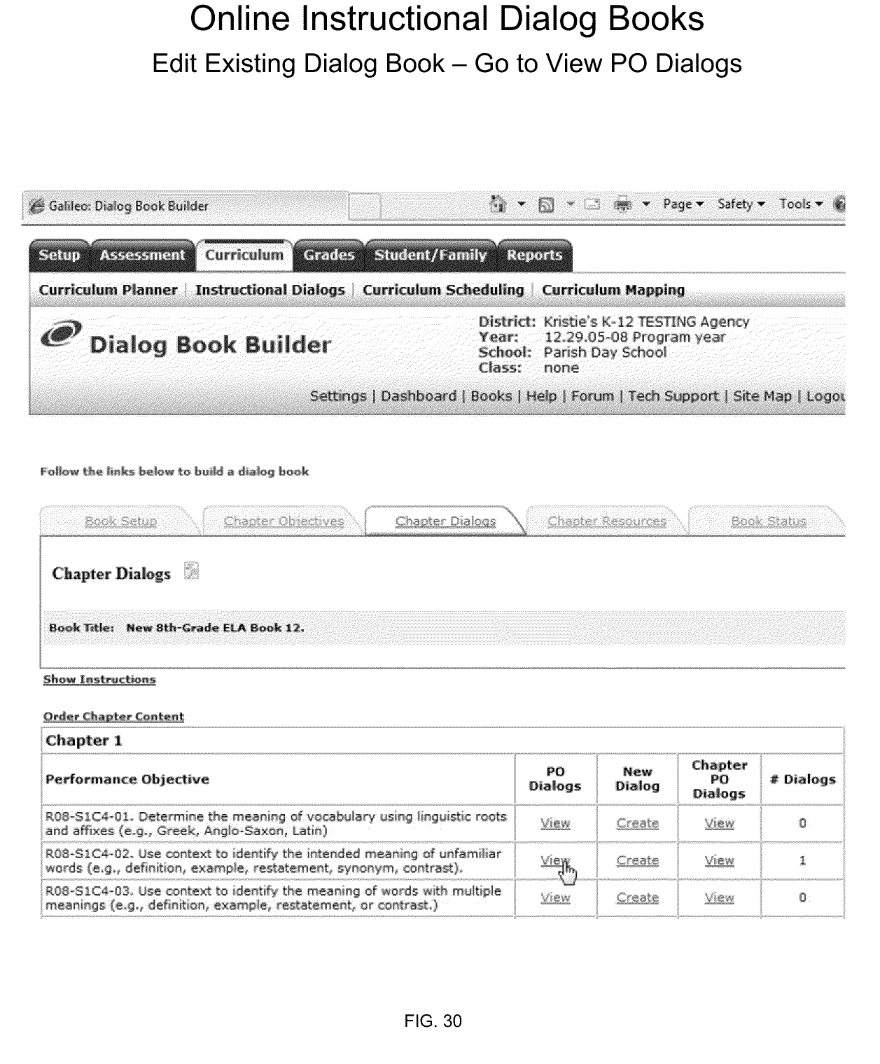

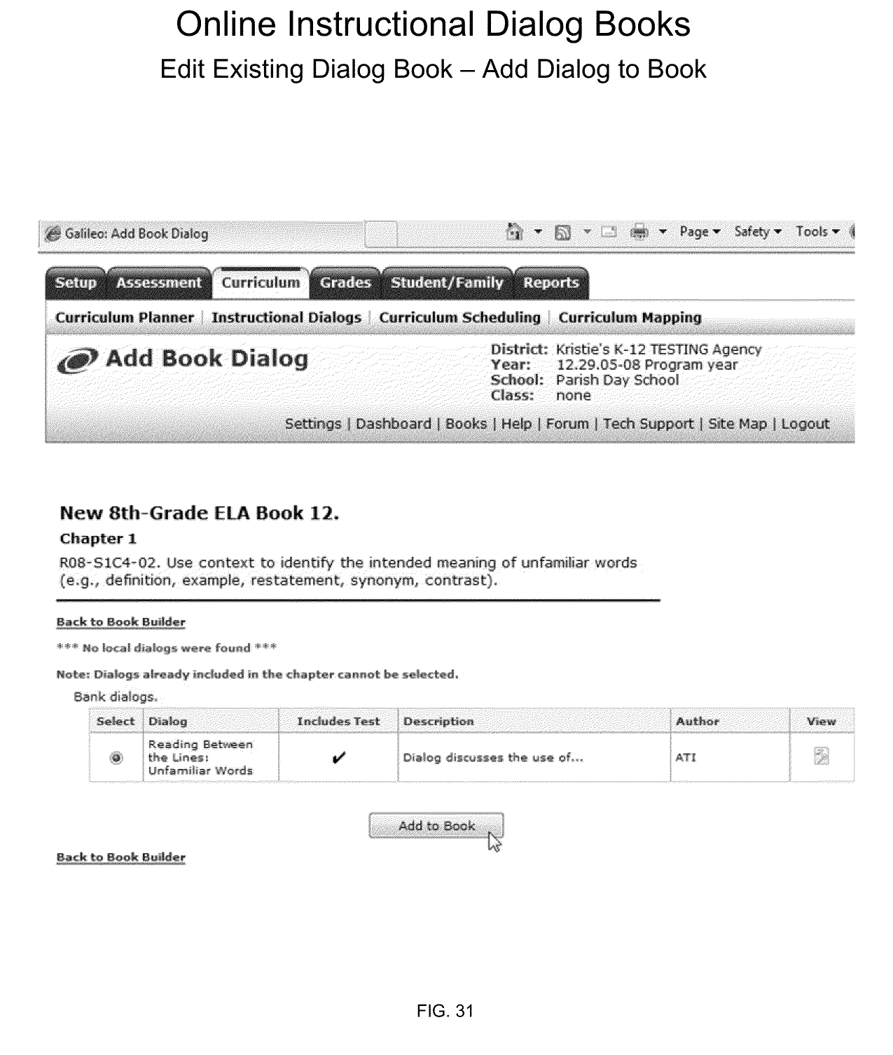

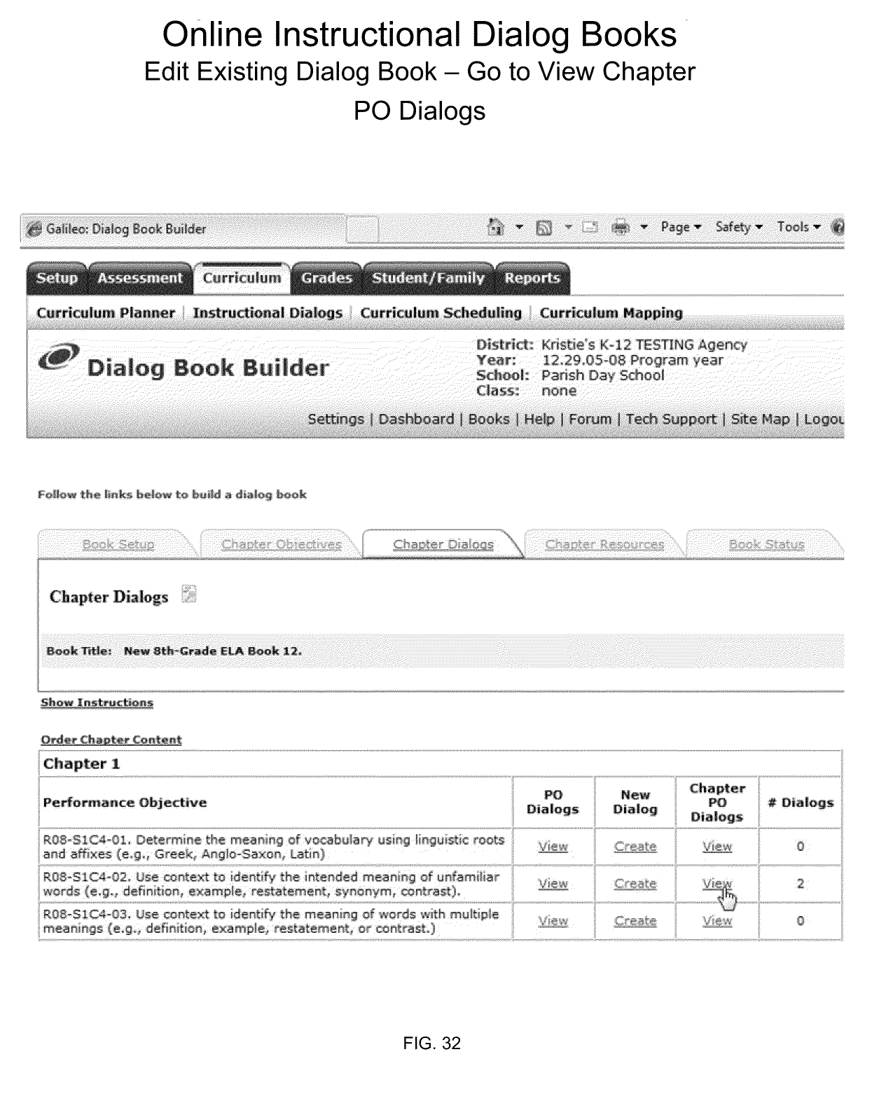

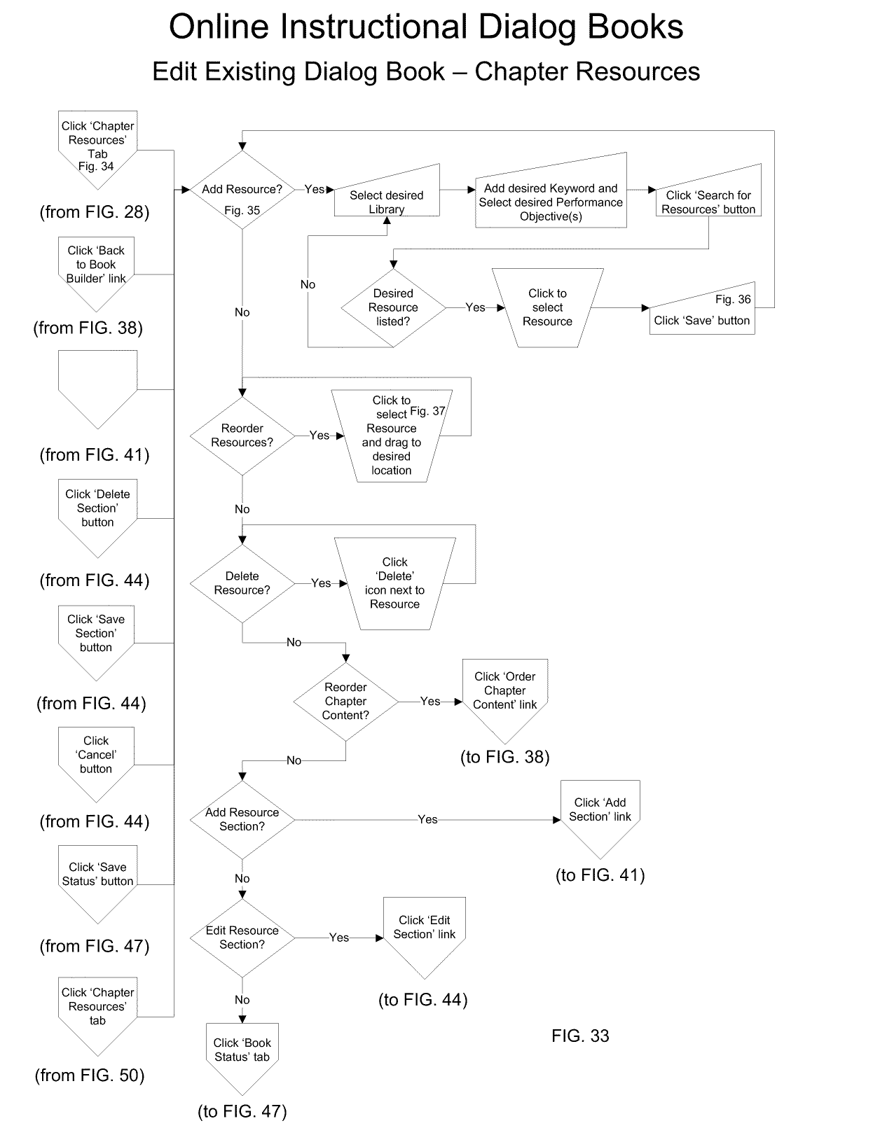

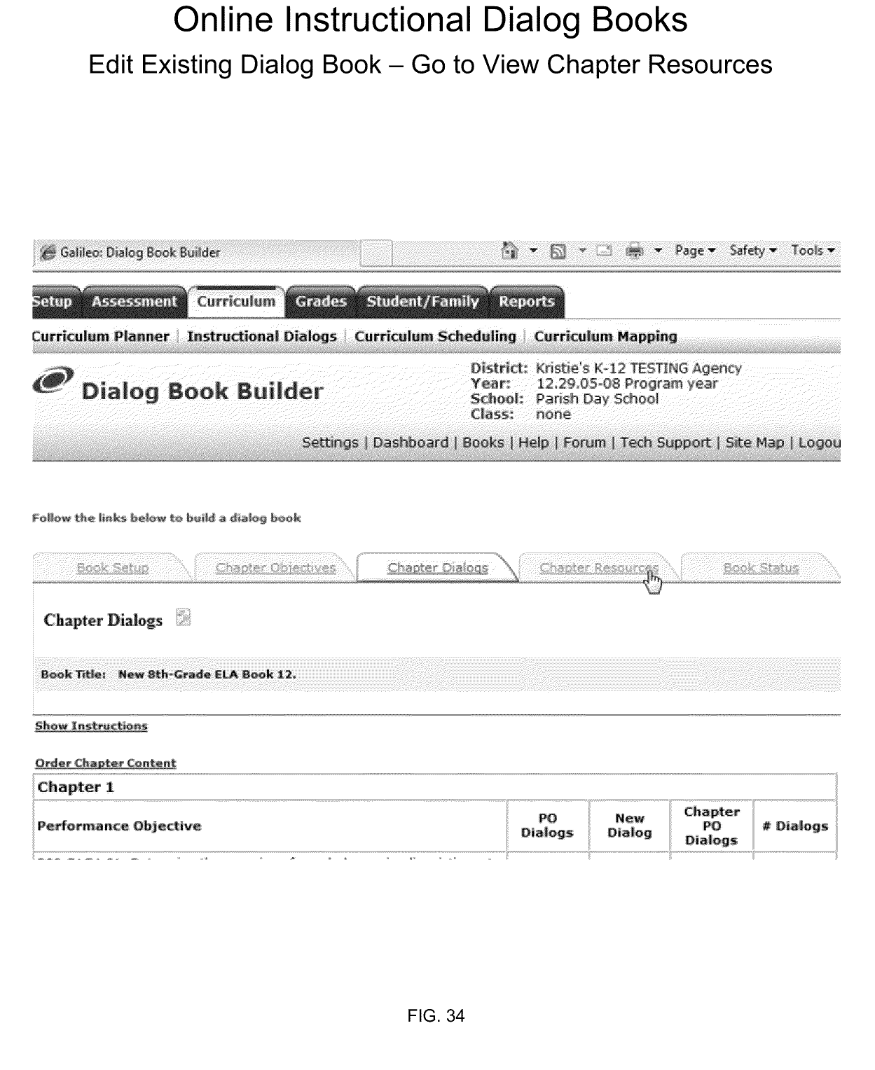

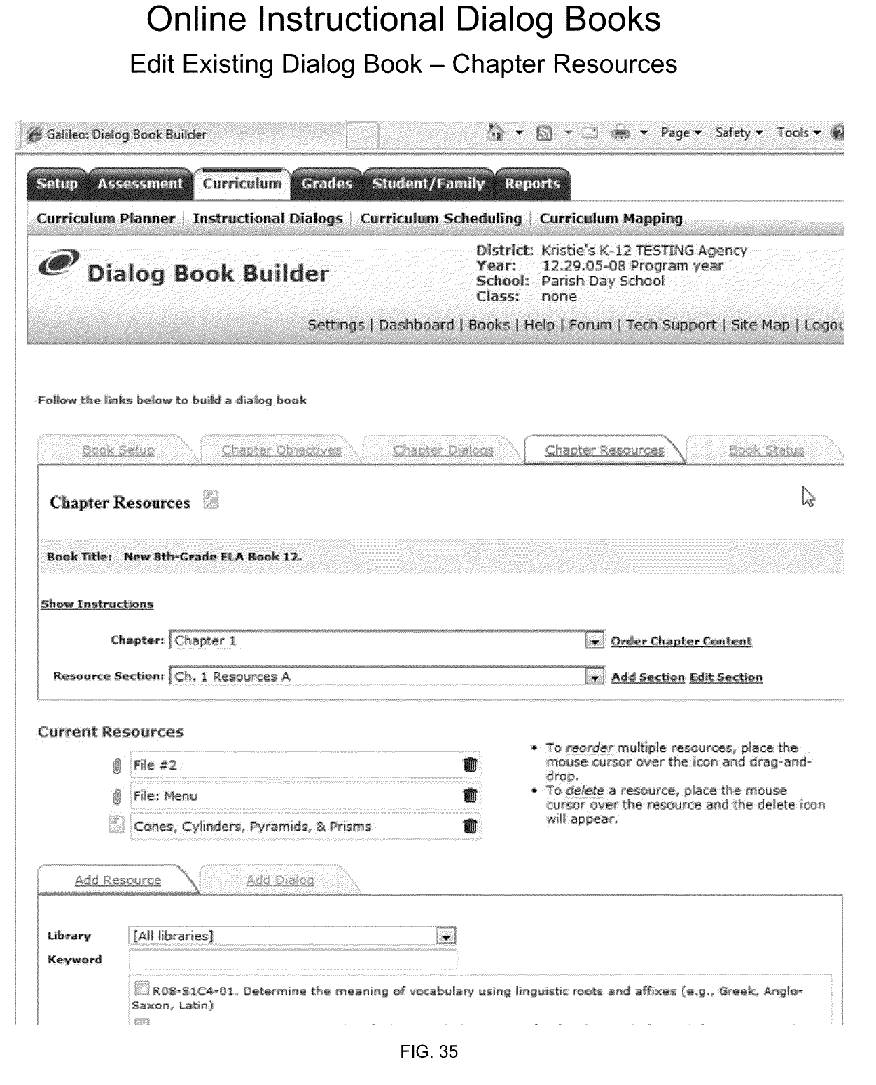

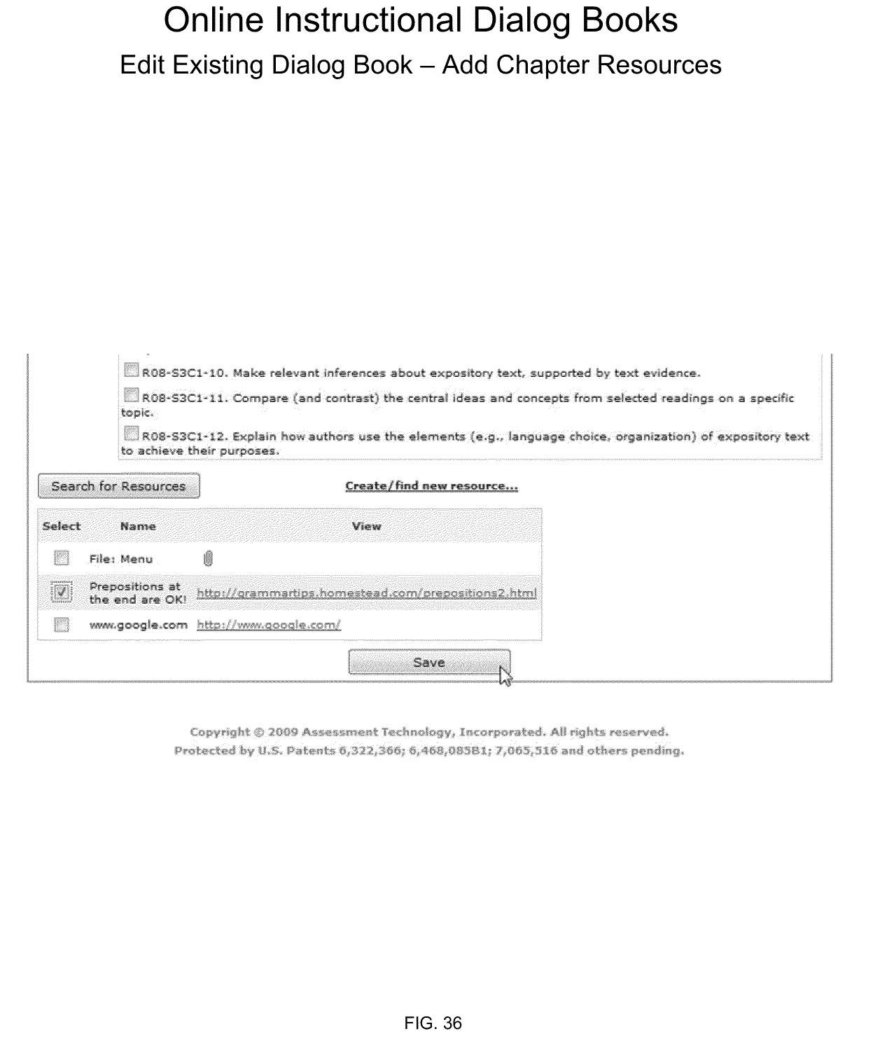

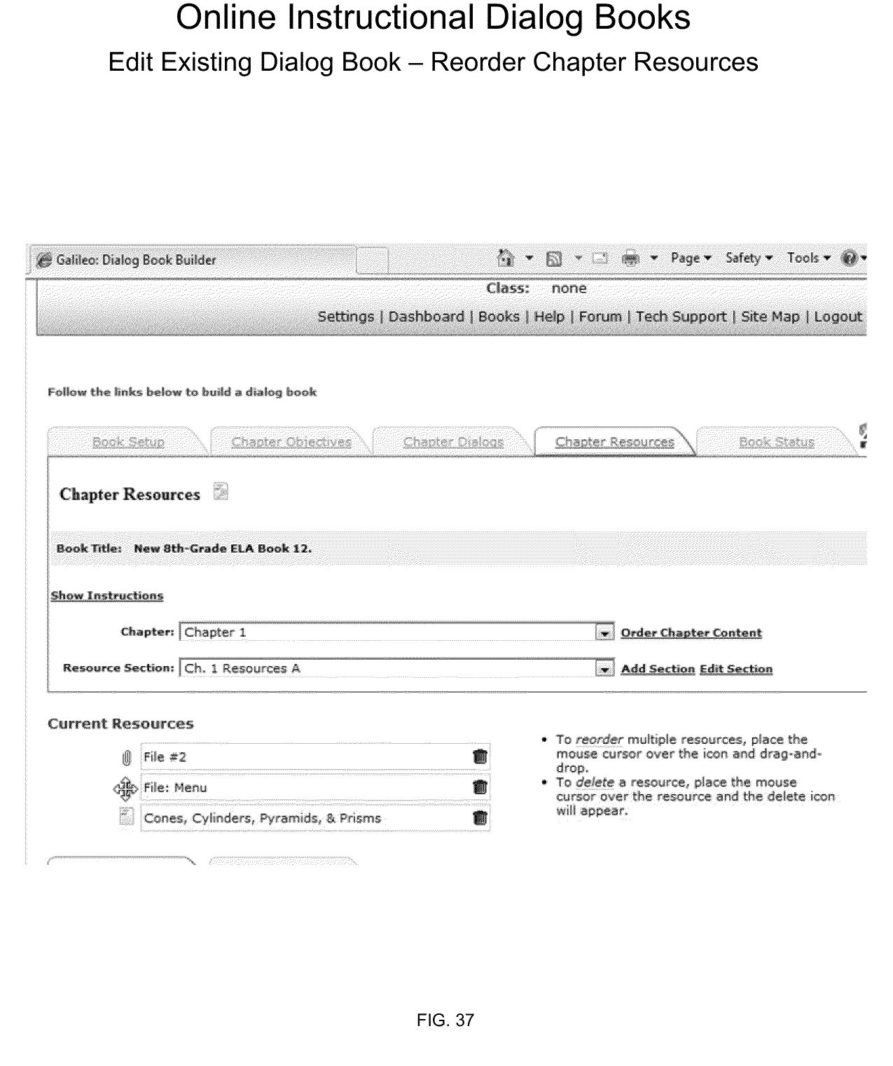

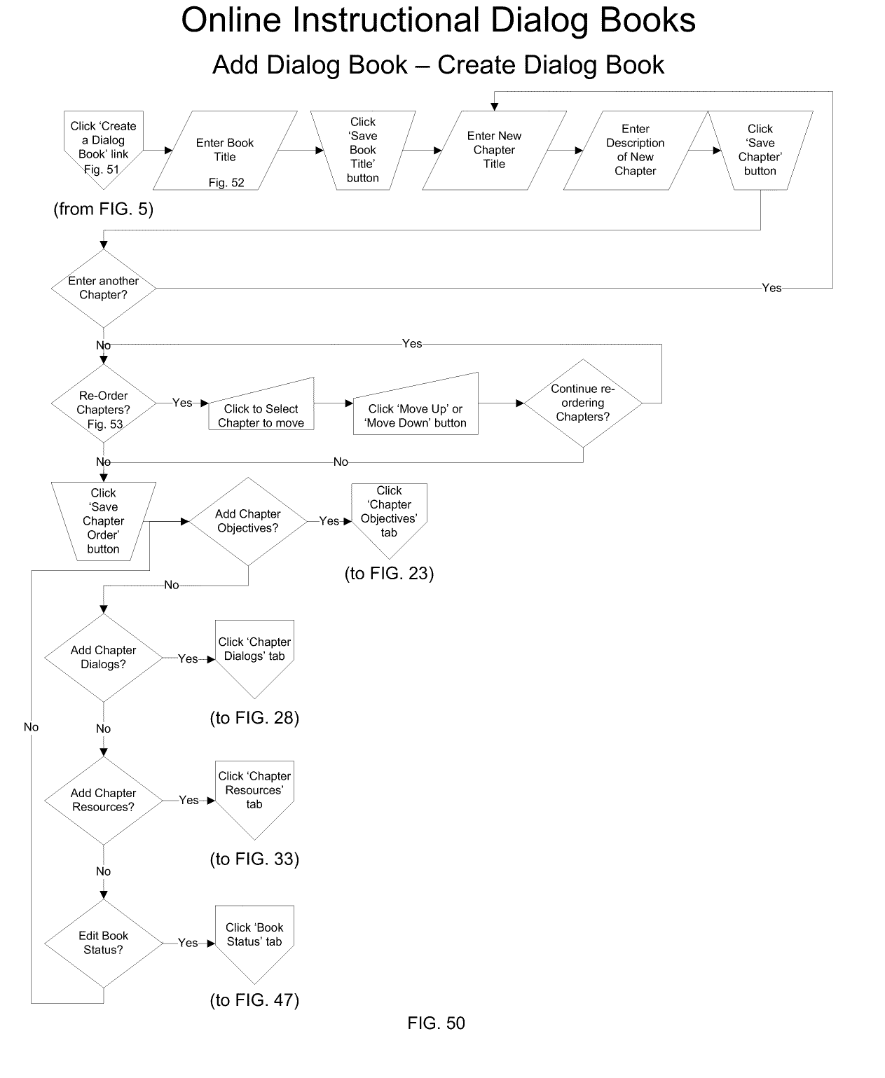

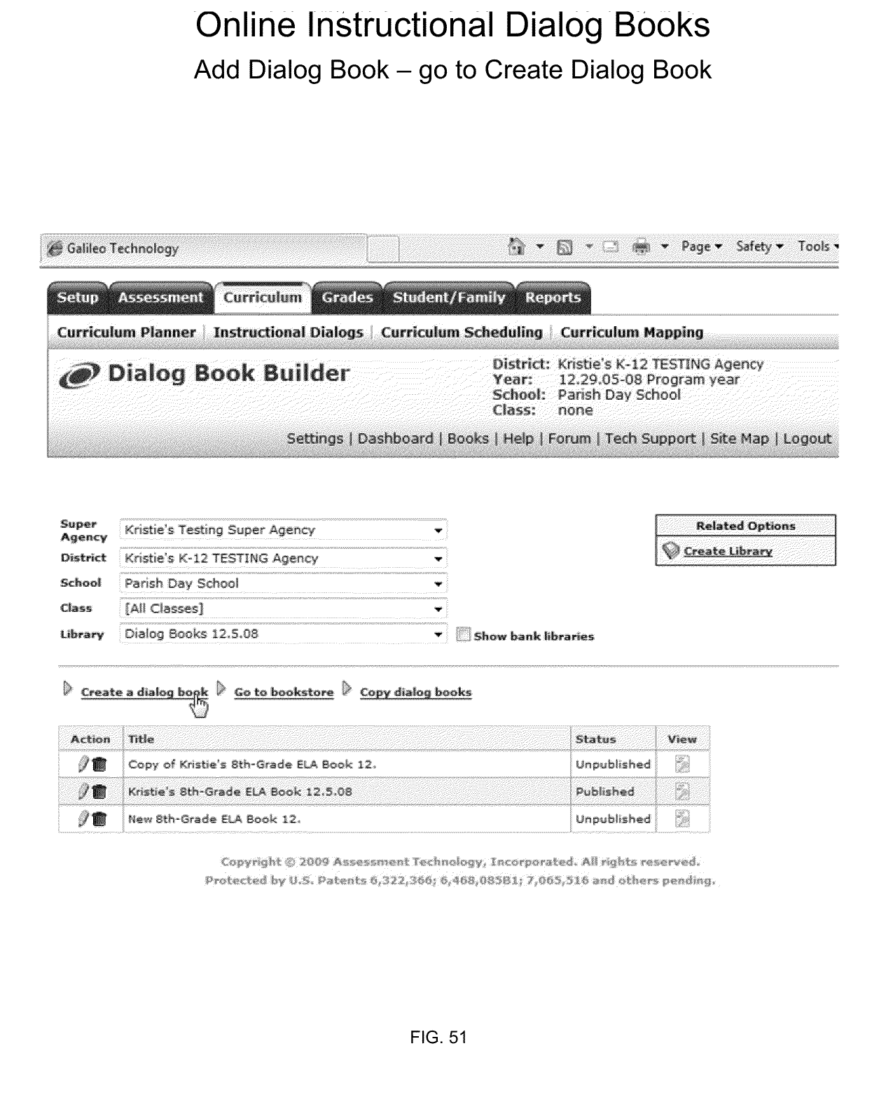

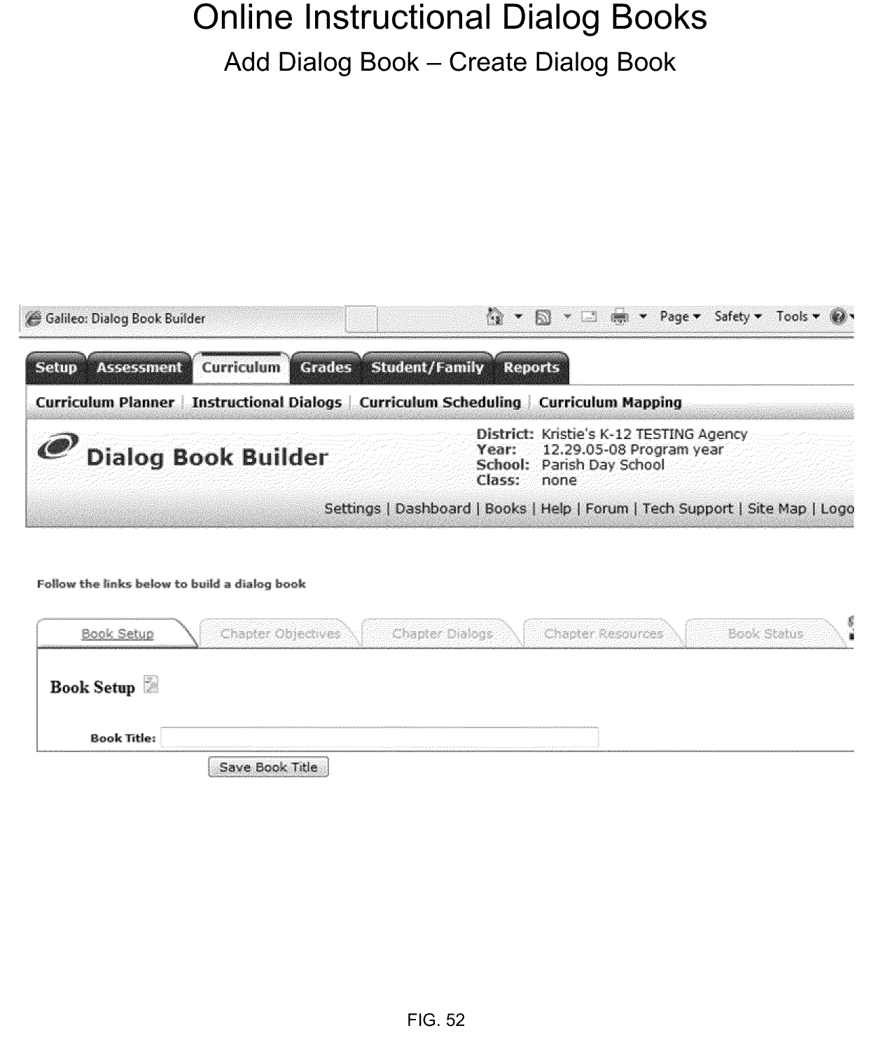

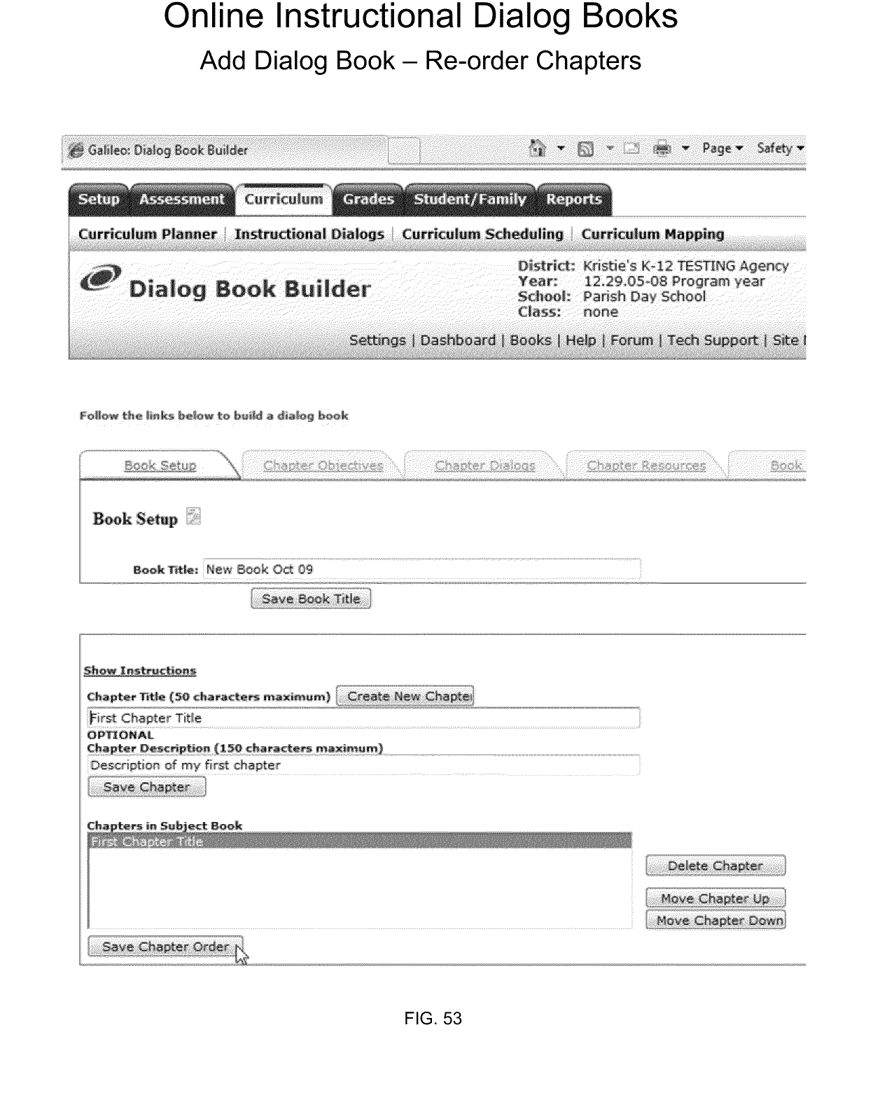

Online Dialog Books provide the technology to organize sets of dialogs into larger instructional units. Online Dialog Books are constructed using a Dialog Book Builder (FIG. 50). The Book Builder enables use user to specify the title of the book, the titles of parts or sections of the book, and the title of book chapters. Chapter dialog content is inserted into the book by using a dialog search feature making it possible to select instructional dialogs aligned to standards for inclusion in a book chapter (FIG. 28). Instructional resource content may also be inserted into a chapter (FIG. 33). In addition, resource content may be inserted into any slide in an Online Instructional Dialog. Resources are selected using a search feature included in Book Builder. Instructional resources may include documents, images, movies, web links, and Online Instructional Dialogs (FIG. 33).

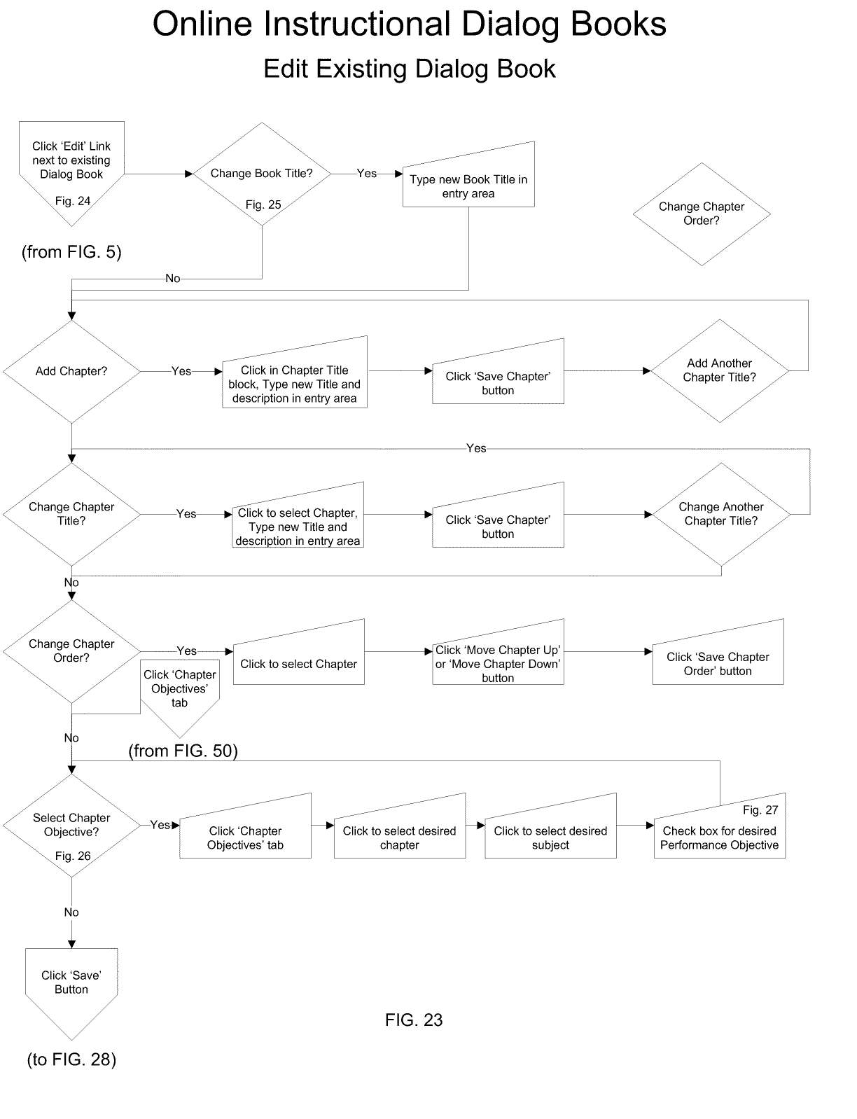

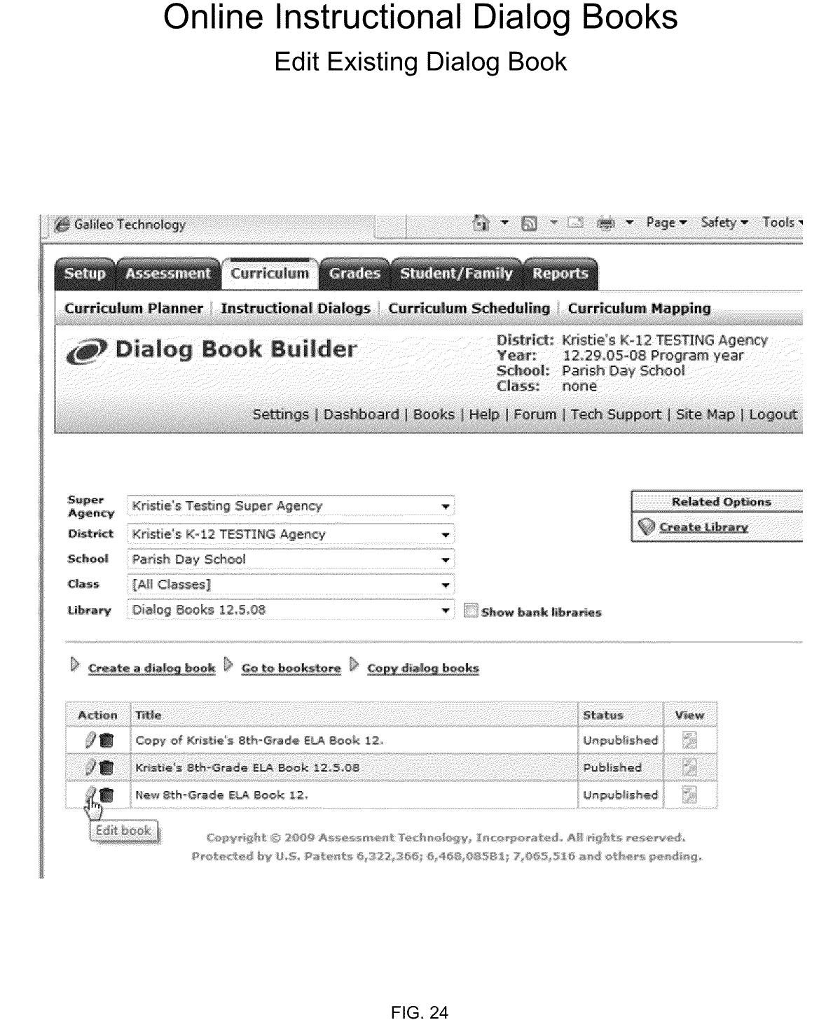

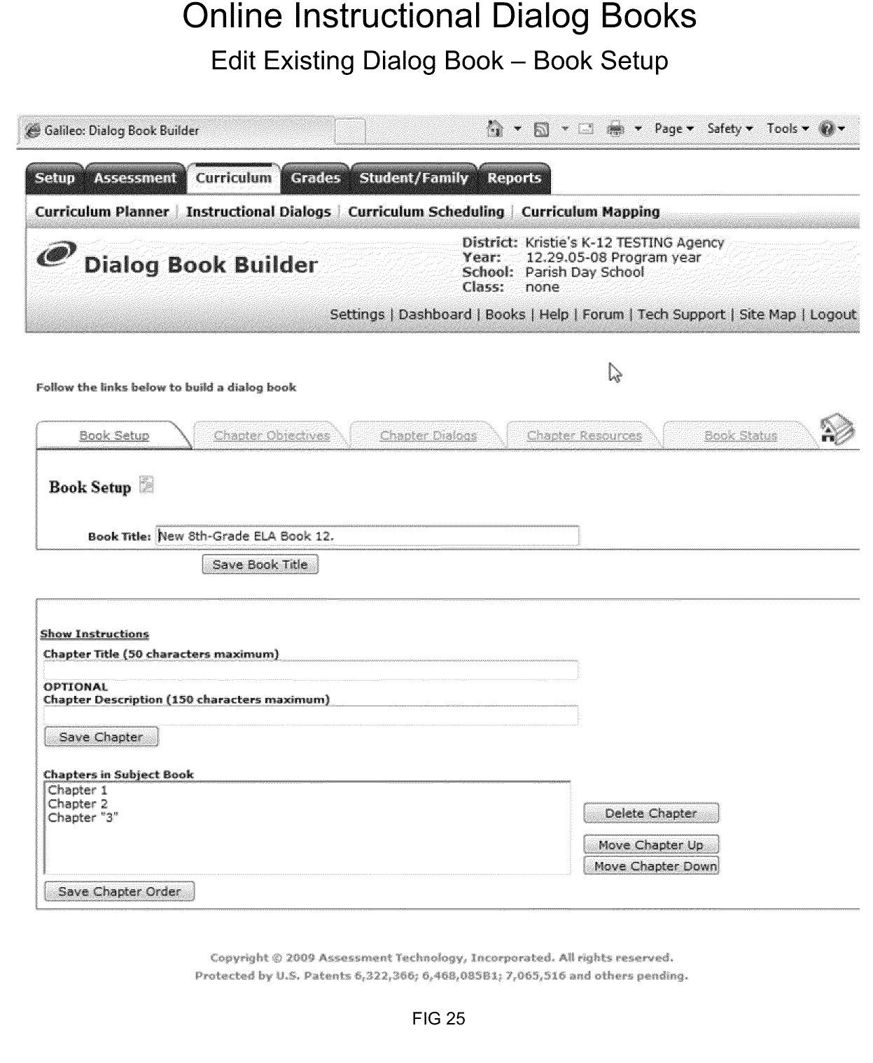

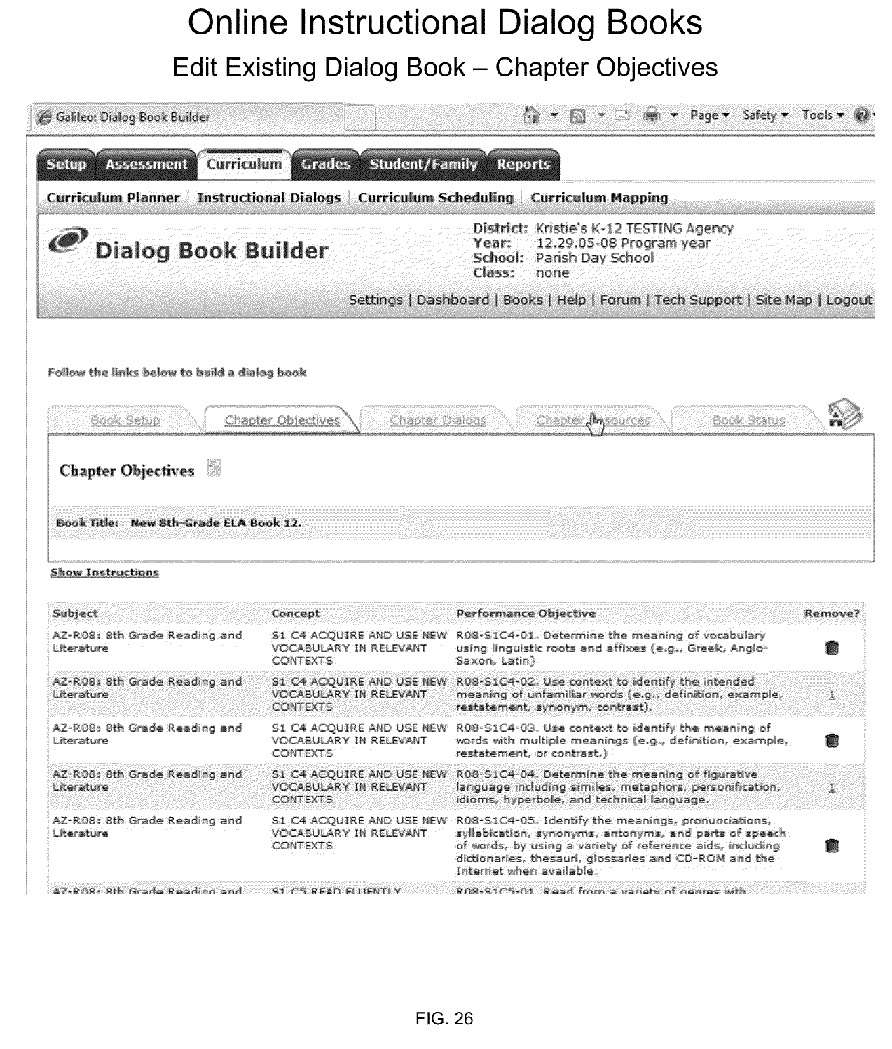

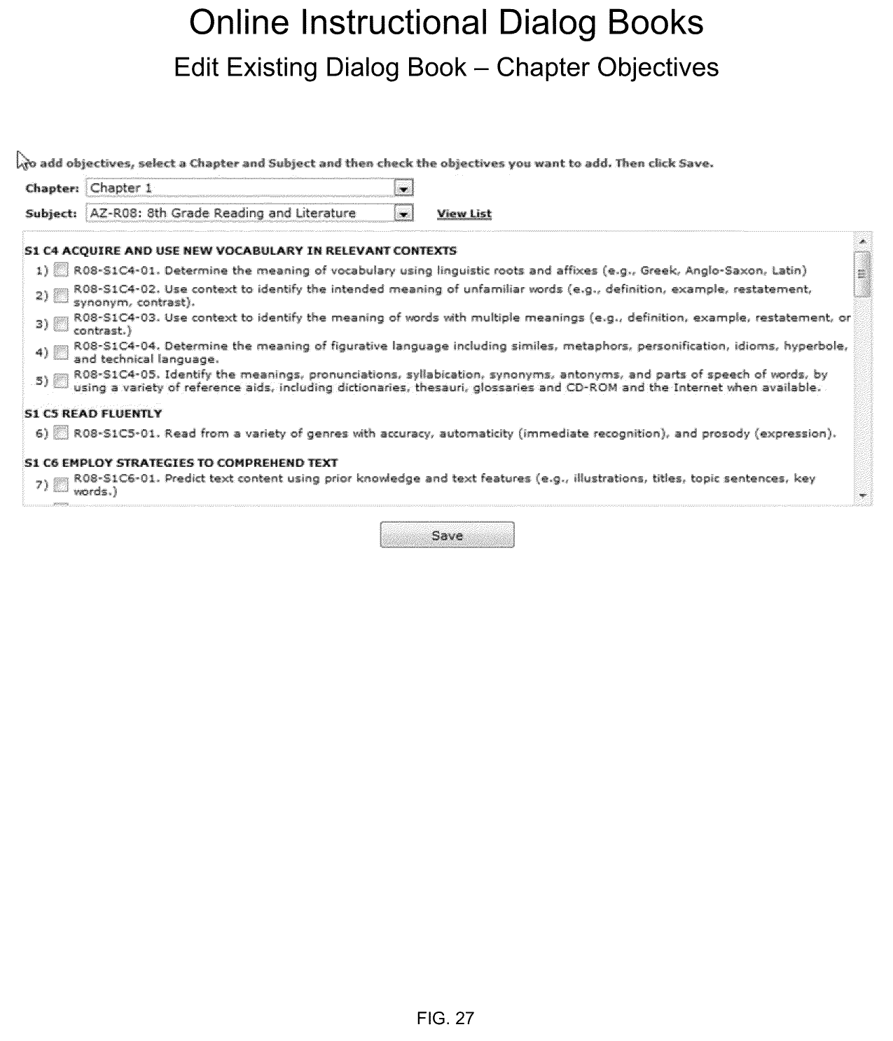

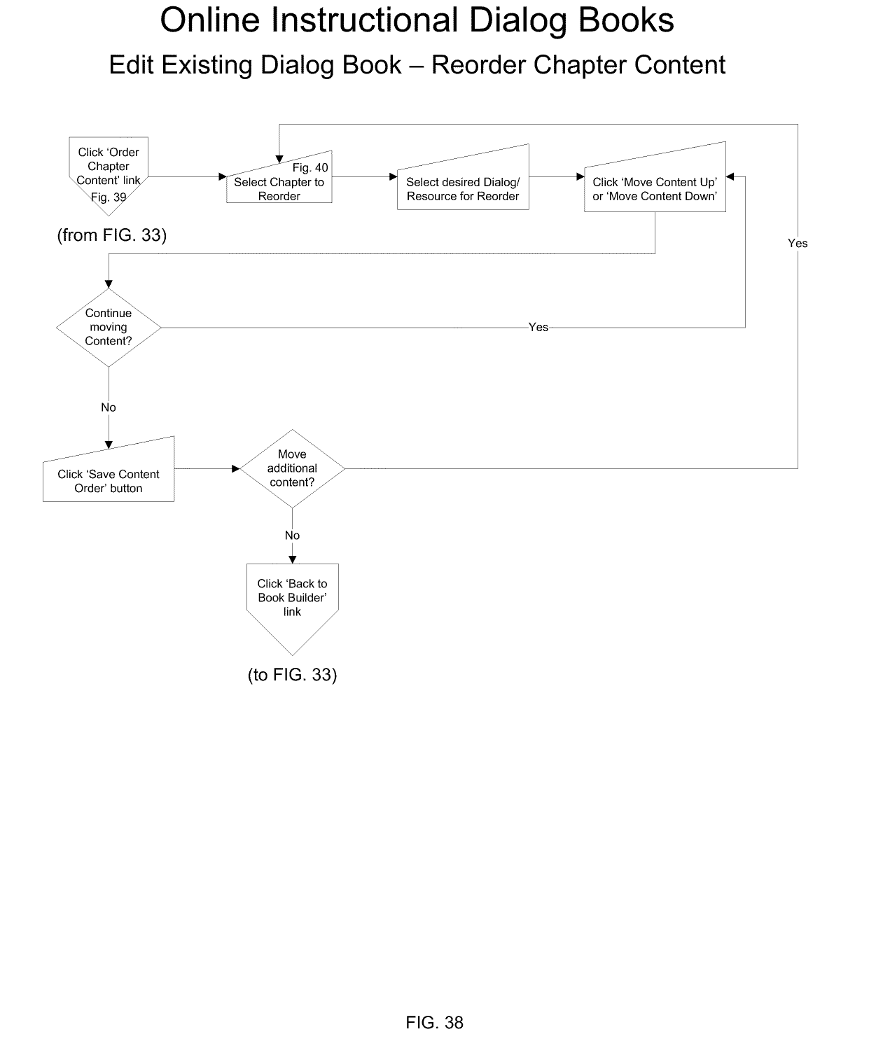

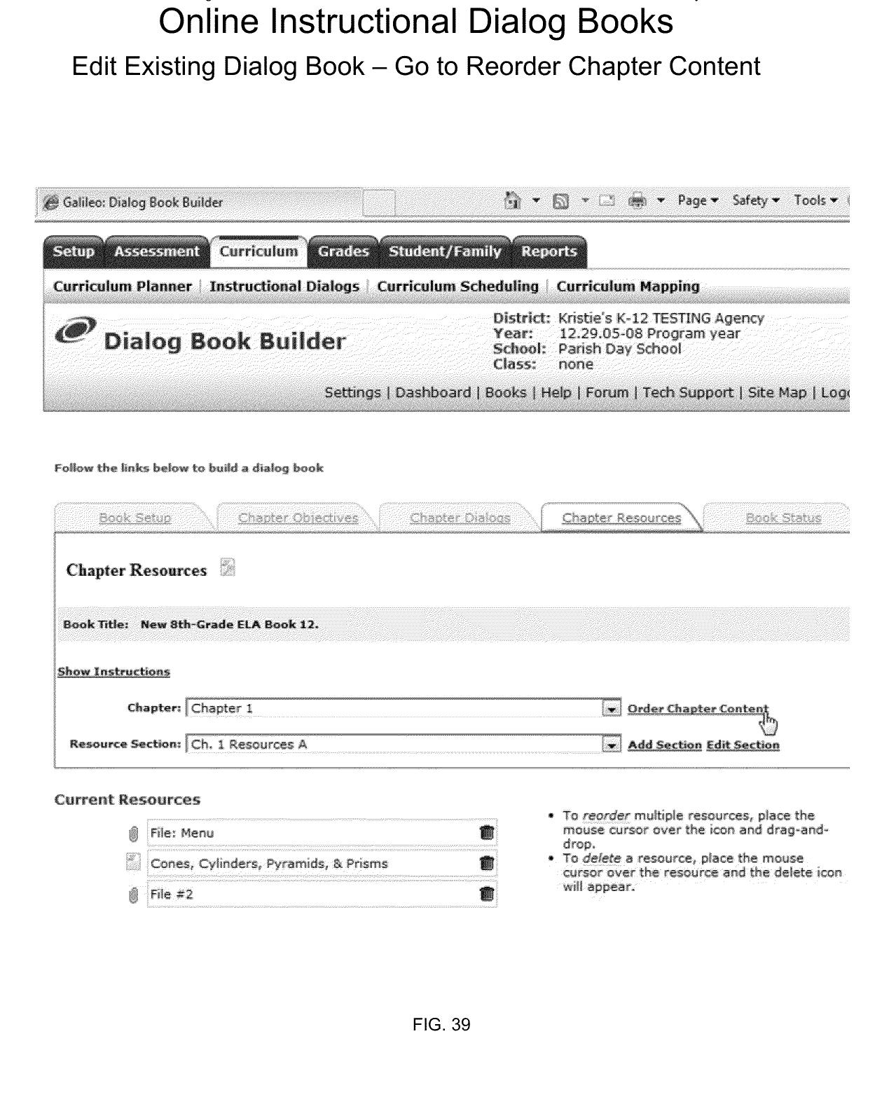

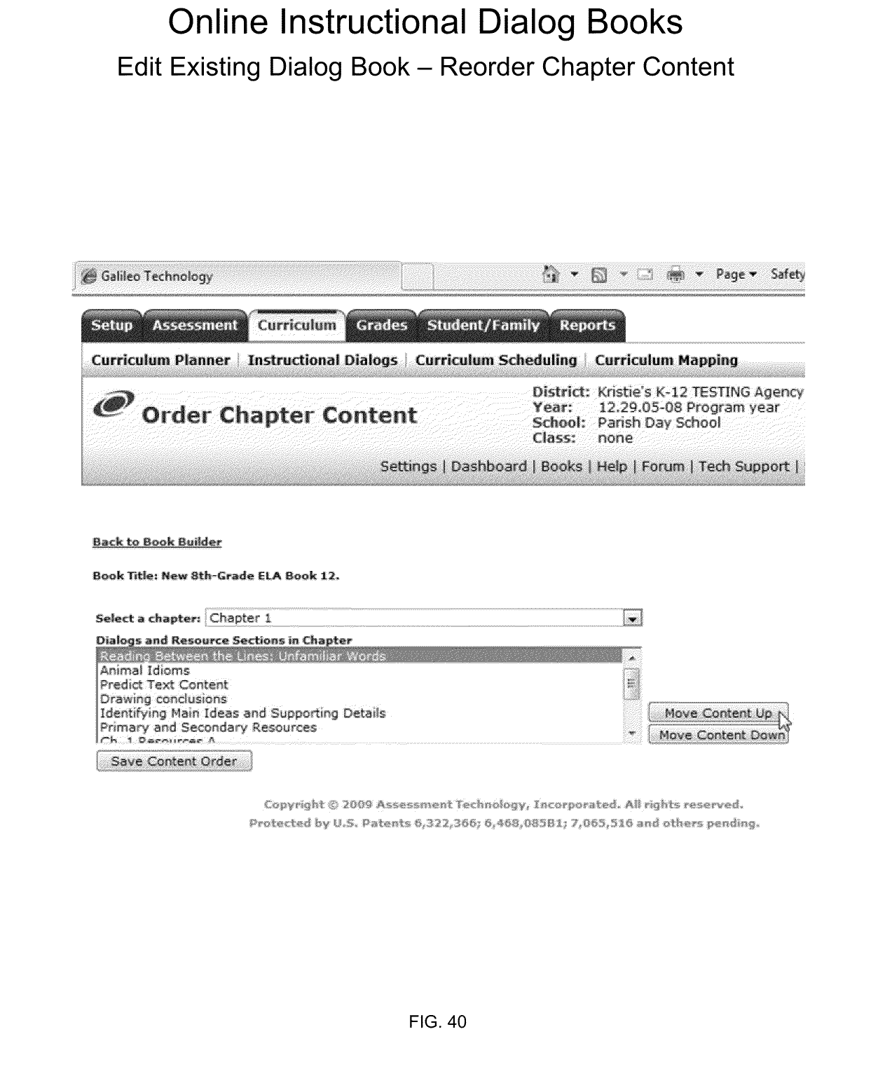

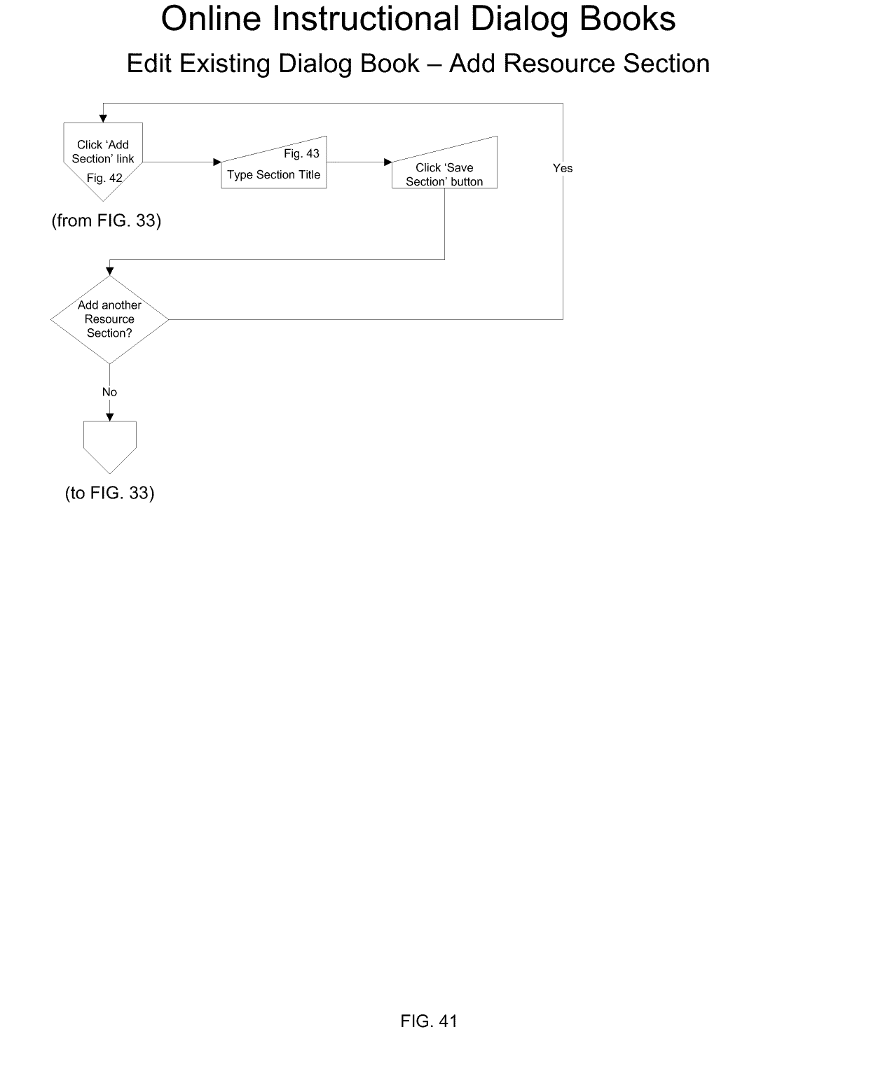

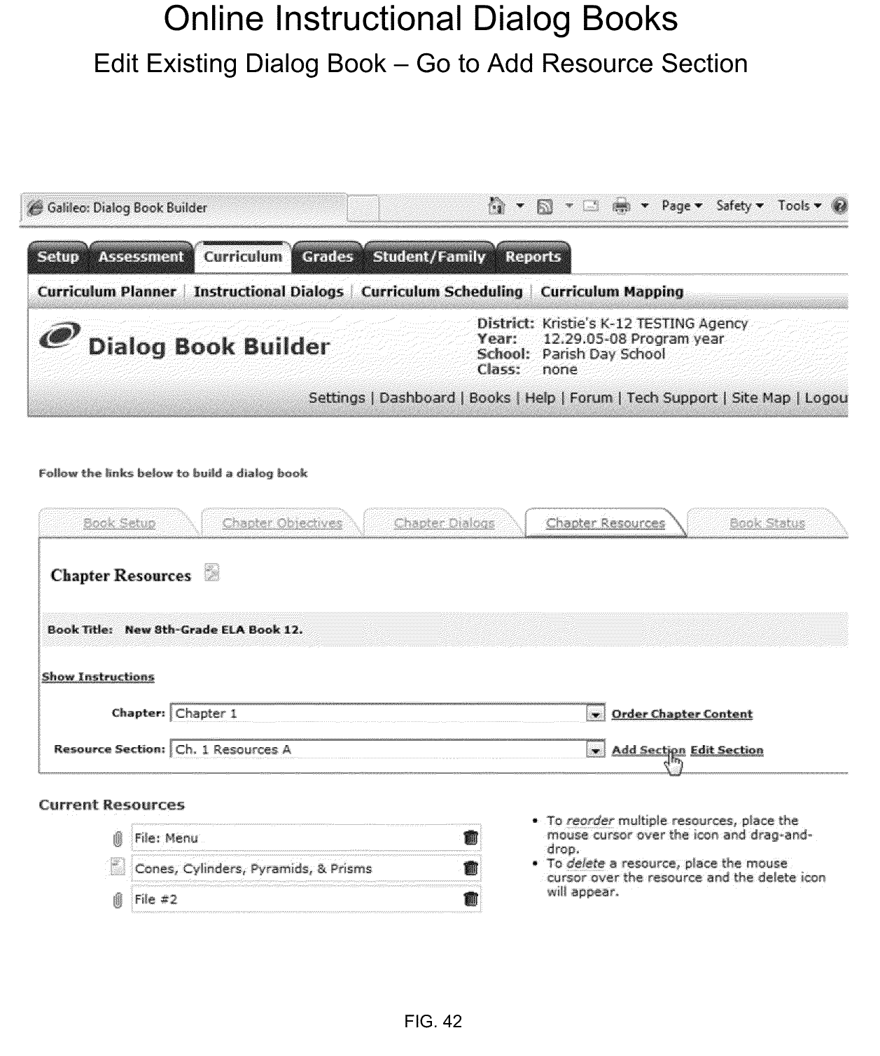

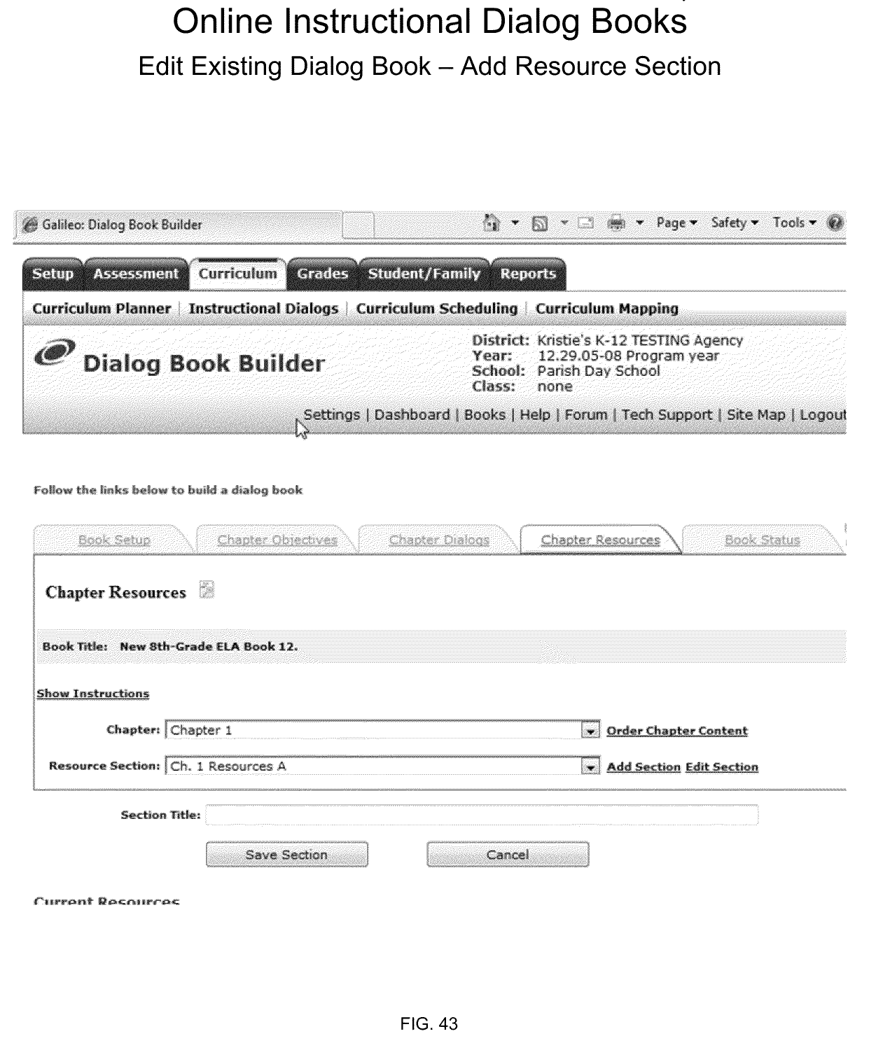

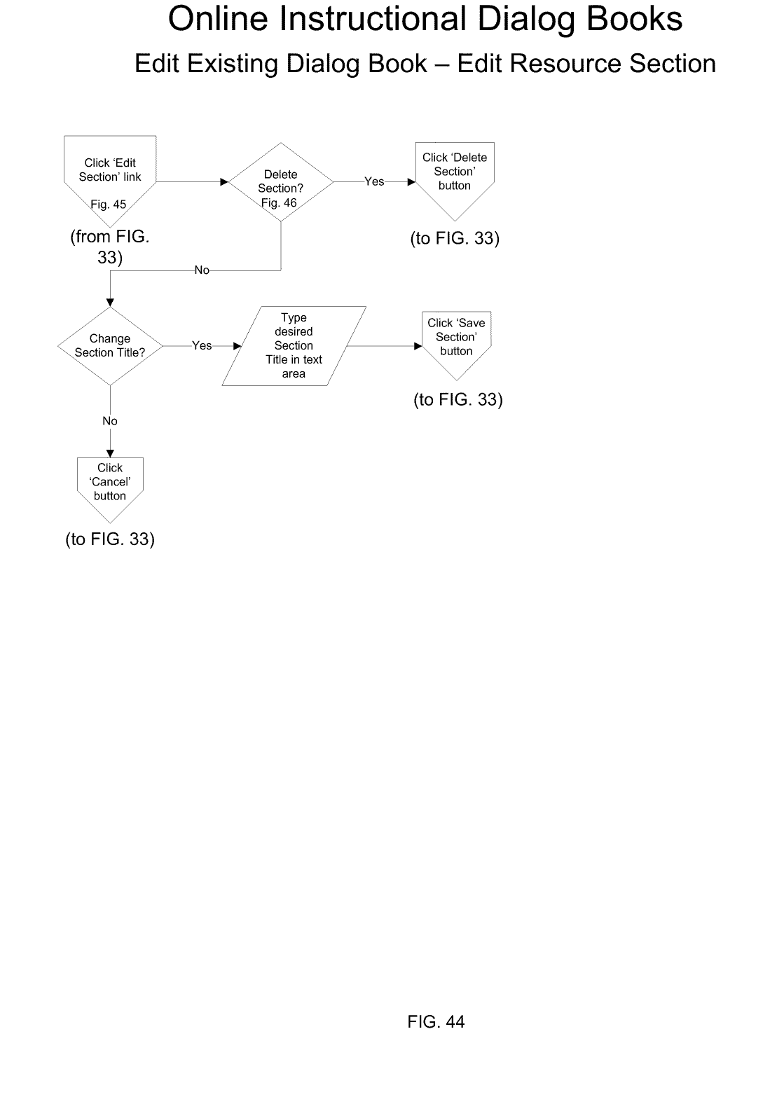

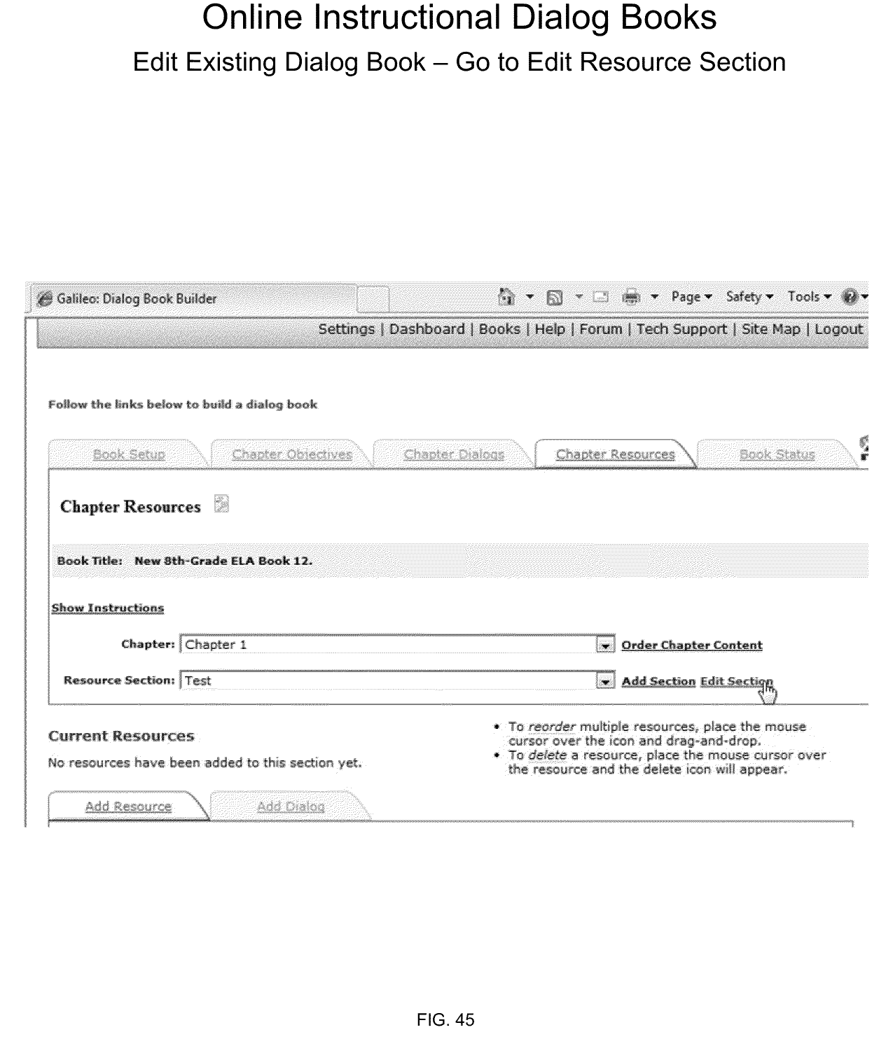

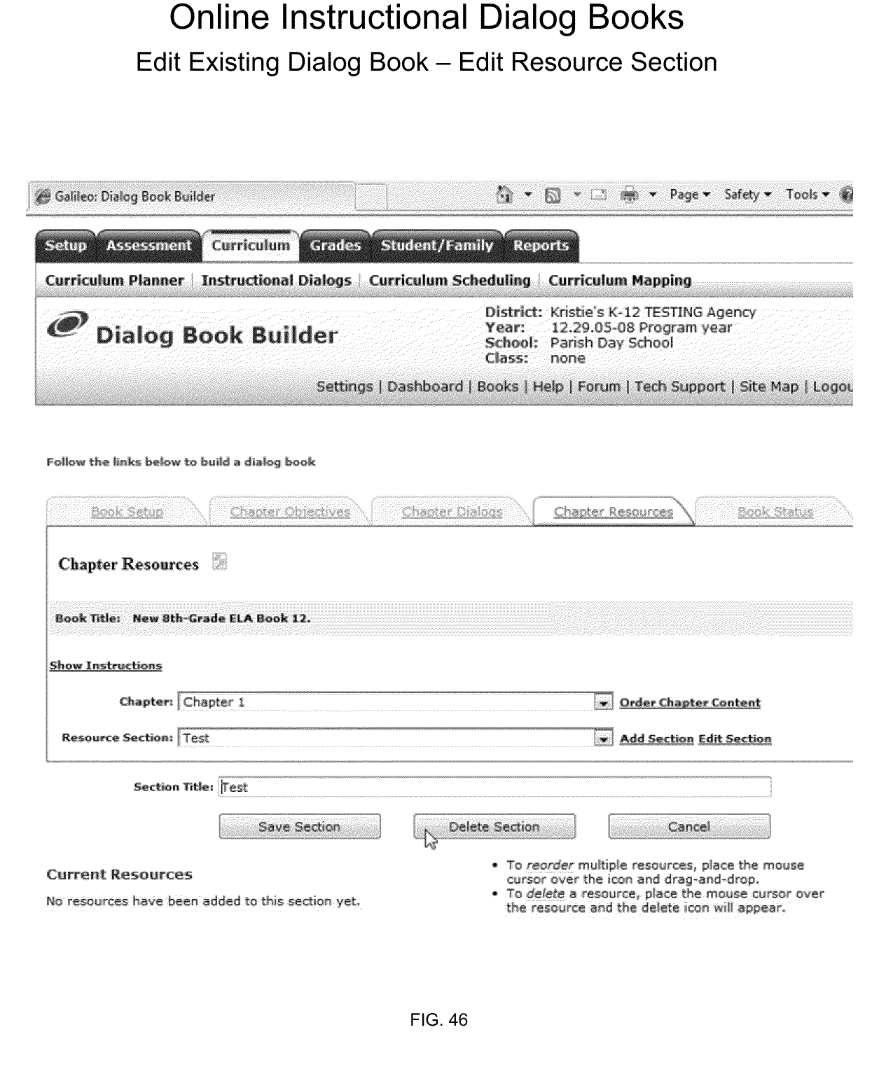

Dialog Books may be edited (FIG. 23). Chapters and sections may be reordered using the Reorder feature in Dialog Book Builder (FIG. 38). Resources and dialogs may also be reordered within a chapter. Dialogs can be deleted from a chapter. New dialogs can be added to a chapter. Likewise, chapters may be deleted or new chapters added to a book.

### Dialog Books and Instructional Planning

Dialog Book Builder includes a feature making it possible to specify the instructional standards to be taught within each chapter in the dialog book under construction (FIG. 23). The first step is to select the categories of standards to be included in the book. For example, a book might include fifth-grade math standards and sixth-grade math standards. Similarly, a book could include math standards and science standards. The ability to include standards reflecting multiple grades and subject areas provides broad flexibility in book design. For example, books can easily be designed for students in advanced placement programs.

After the categories have been determined, the user may select the specific standards to be included in a given chapter and the dialogs to be included for each standard. The selection interface enables the user to specify the number of dialogs desired for a given standard. In addition, the interface indicates the number of dialogs available for that standard. The user may view dialogs already selected for a given standard and dialogs available from ATI dialog banks for that standard. If the user does not find a dialog to his or her liking, the user is given the option of creating a new dialog.

The specification of standards and instructional dialogs for each chapter links curricular scope and sequence directly to instructional activities. Because the links are customizable, curricular materials can be continually reorganized to reflect changing standards and evolving educational needs characteristic of the modern world.

The specification of standards and instructional dialogs for each chapter links curricular scope and sequence directly to instructional activities. Because the links are customizable, curricular materials can be continually reorganized to reflect changing standards and evolving educational needs characteristic of the modern world.

Aligning Dialogs and Dialog Books to Standards across States

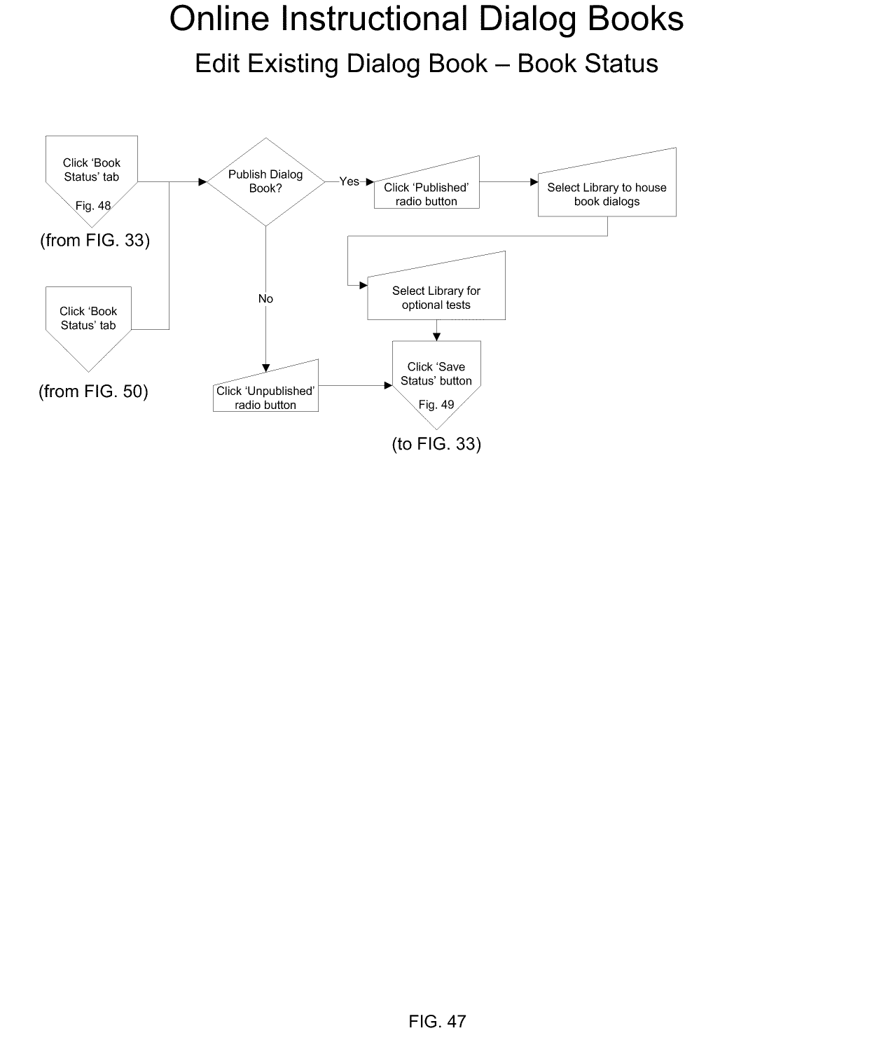

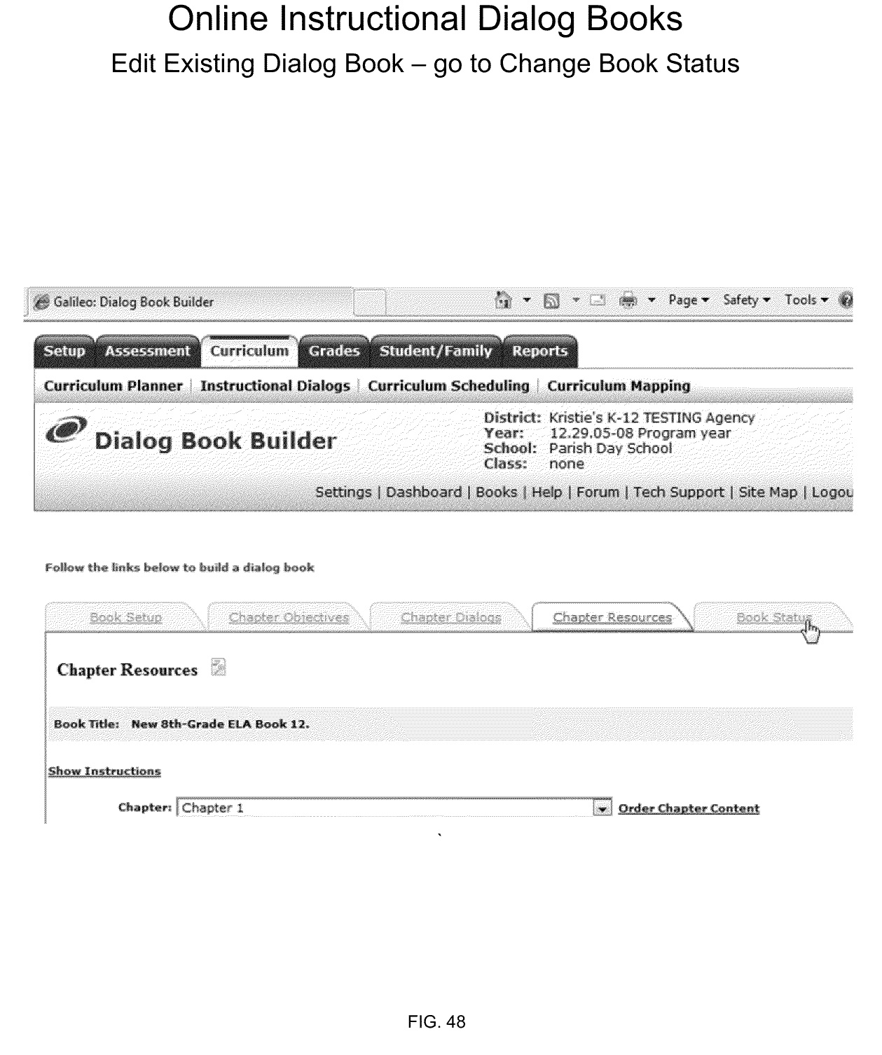

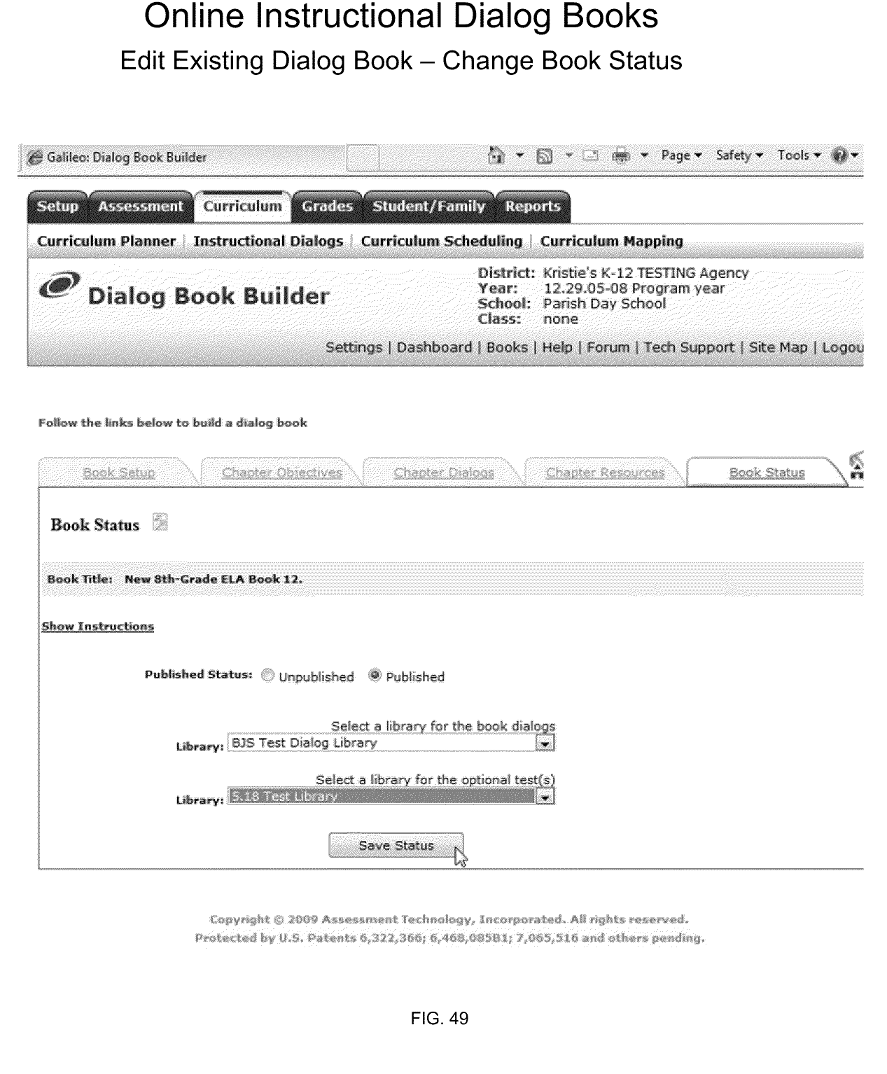

Dialogs created by users in one district can be shared with users in other districts by selecting the sharing option when the dialog is published (FIG. 47). The sharing option includes a unique mapping utility, which automatically aligns shared dialogs to item specifications associated with the dialog. The item specifications can be mapped to multiple sets of standards including standards in multiple states as well as national standards. For example, when the shared dialog includes an optional test, the dialog is mapped to item specifications which, in turn, can be mapped to multiple sets of standards. This provides a significant benefit in that it makes it unnecessary to map dialogs separately to standards assessed by the optional test. This saves a very large amount of time in the mapping process. Mapping occurs as follows: Each dialog is linked to one or more items specifications providing a detailed description of the defining characteristics of the items that may be used in assessing the mastery of standards targeted for instruction in the dialog. The item specifications are aligned to multiple sets of standards including standards in multiple states. When the specifications are mapped, any dialogs assigned to the specification are also automatically mapped.

Dialog books may be mapped across states in much the same way as that used with individual dialogs. Test items included in individual dialogs are mapped to specifications, which in turn are mapped to standards in multiple states. Dialogs are mapped to item specifications as described in the preceding paragraph. If all of the dialogs included in a book can be mapped to standards in a given state, then the dialog book is mapped to the standards in that state. Complexity arises when one or more dialogs in the book cannot be mapped to standards in the new state. Under these conditions, the mapping utility identifies standards closely associated with the capabilities measured by the test items. The user has the option of including or not including dialogs that cannot be mapped across states.

Selecting Books from the Dialog Book Store

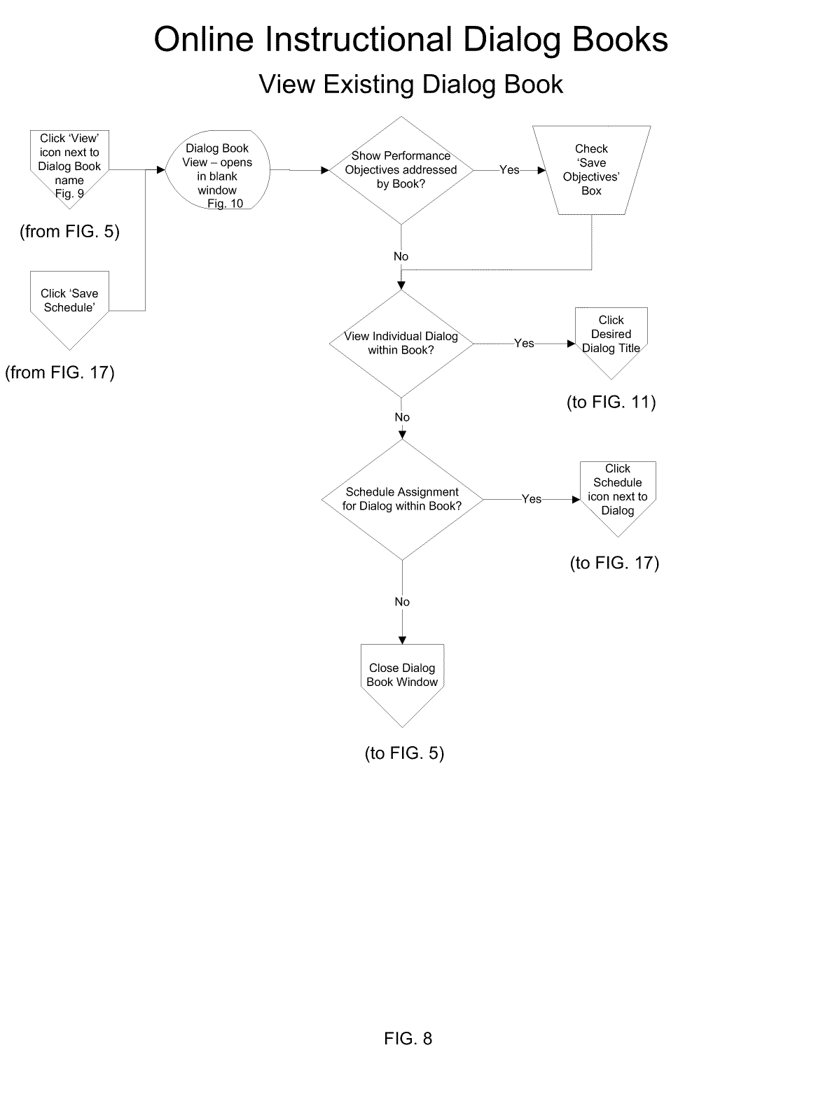

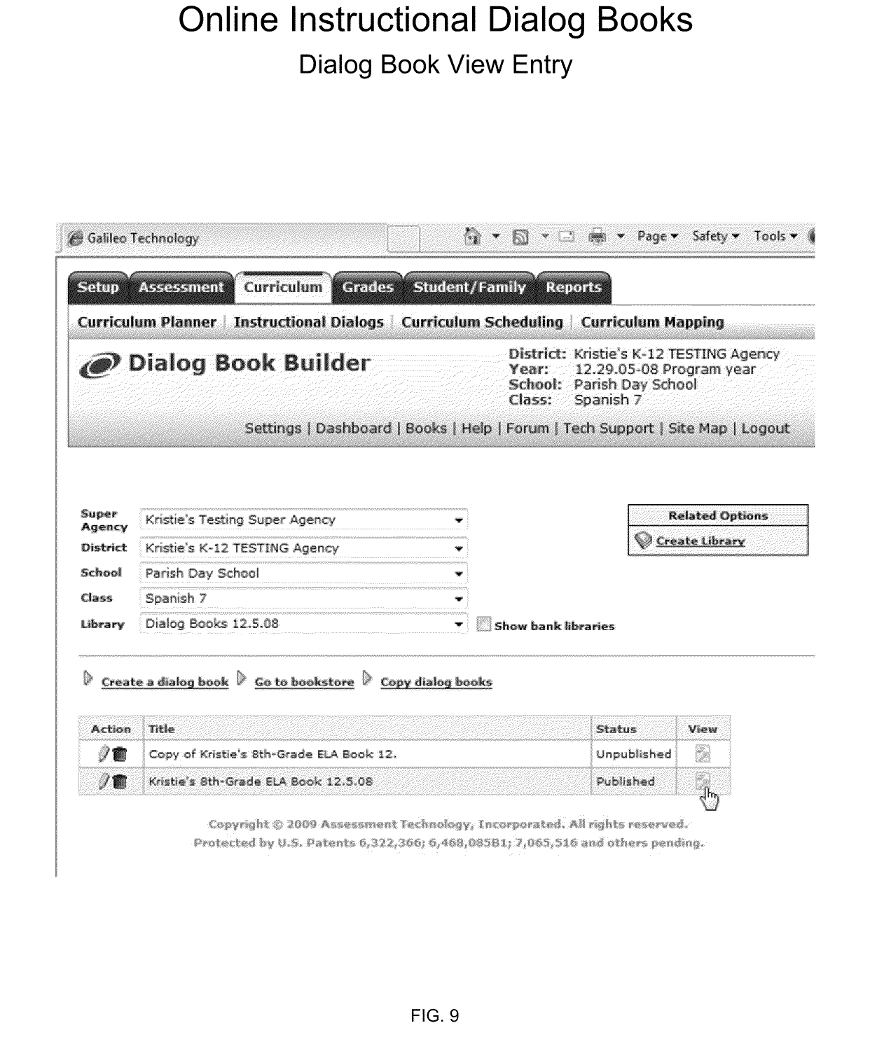

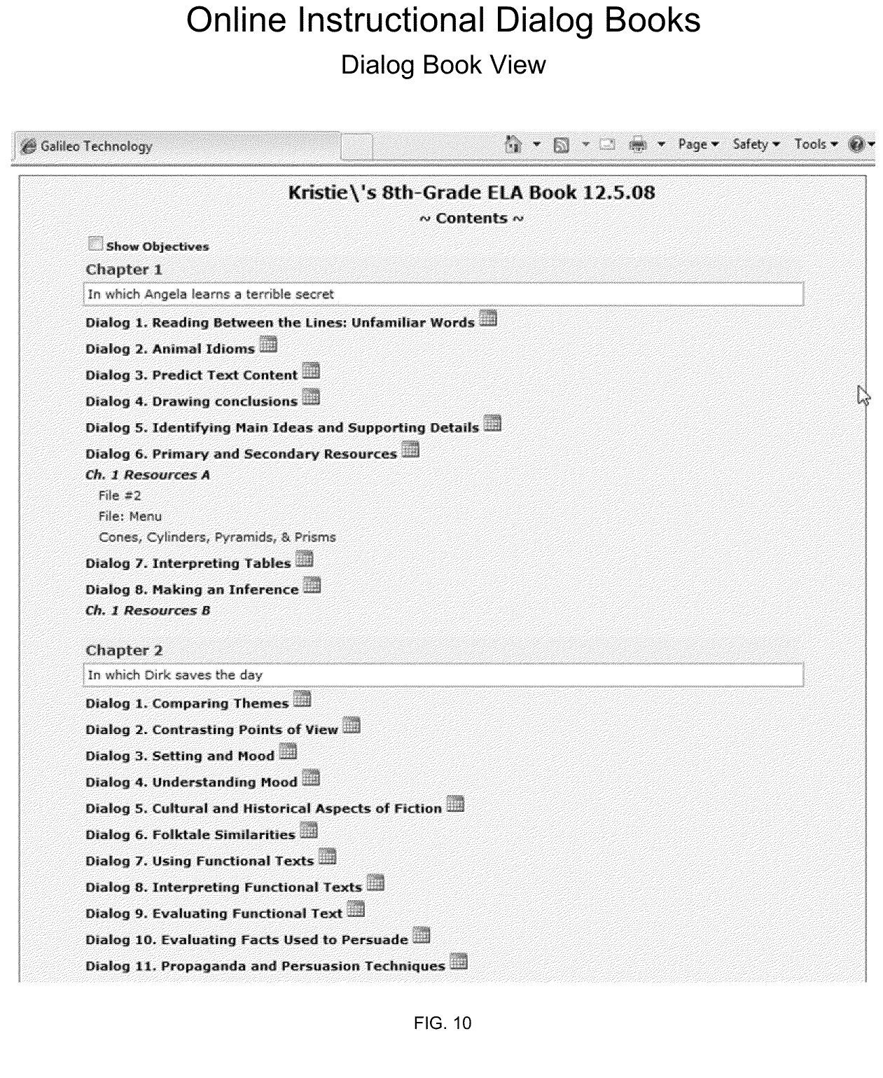

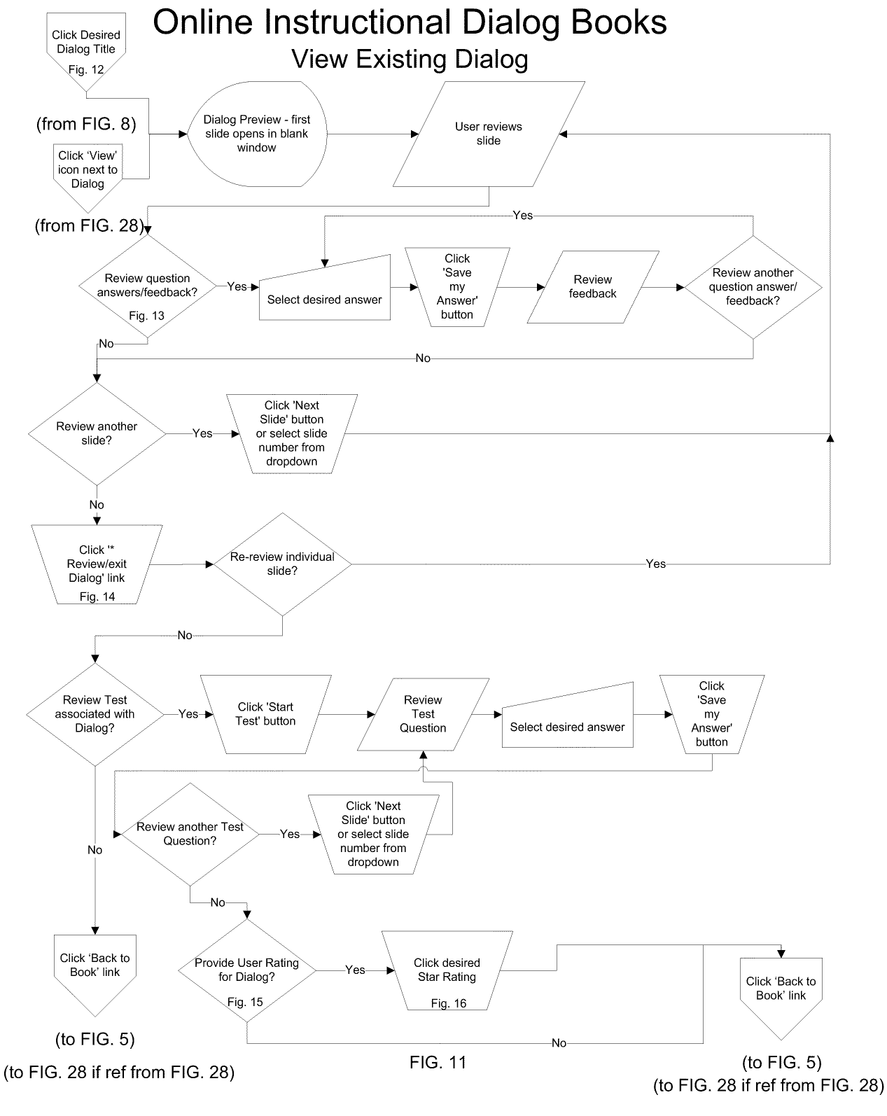

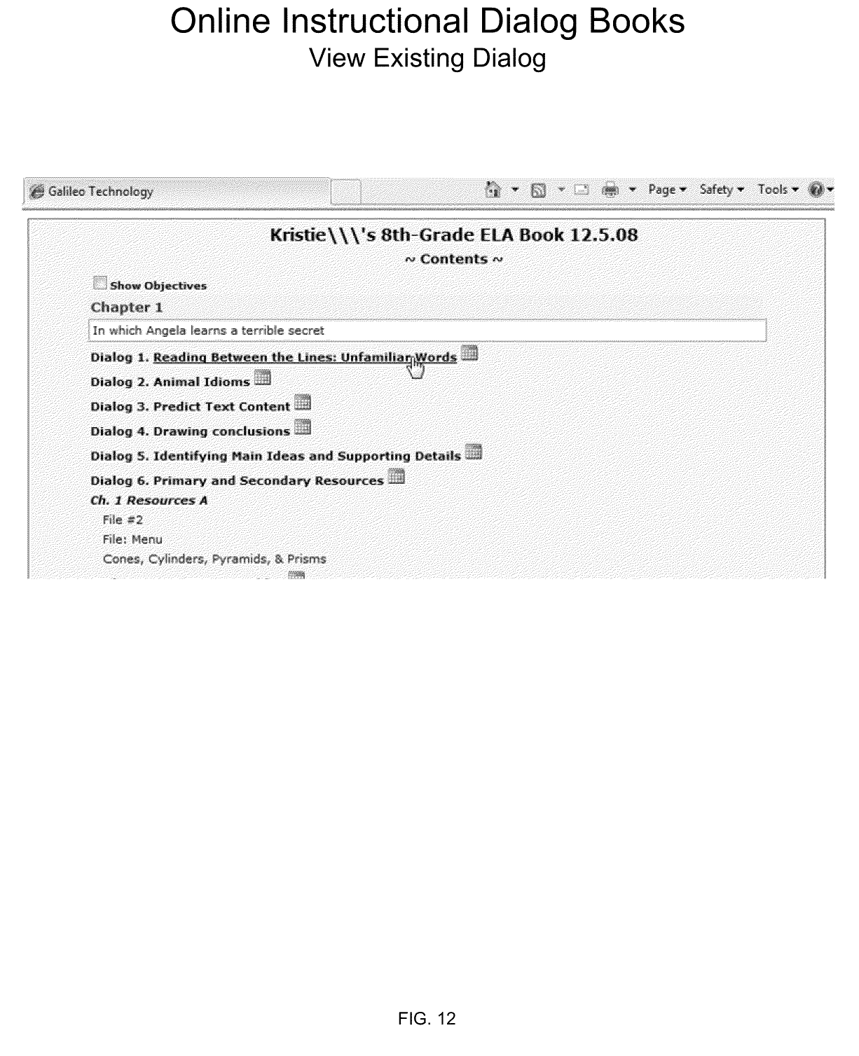

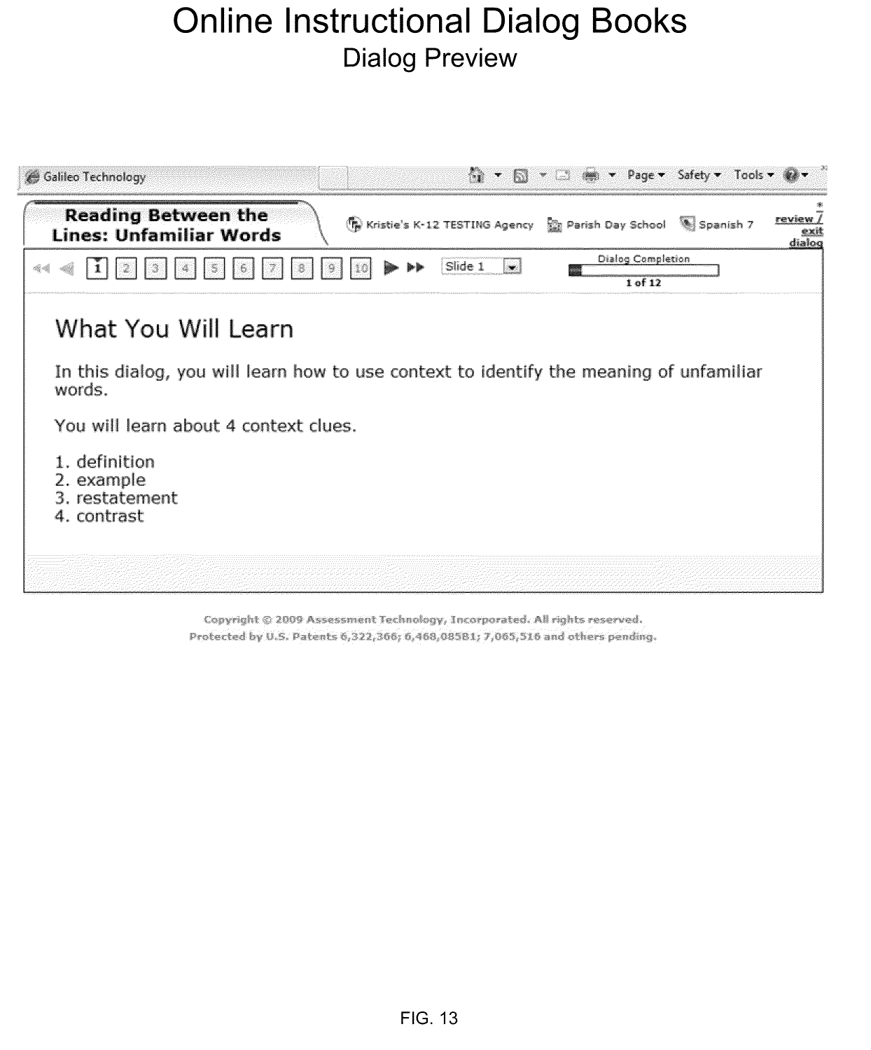

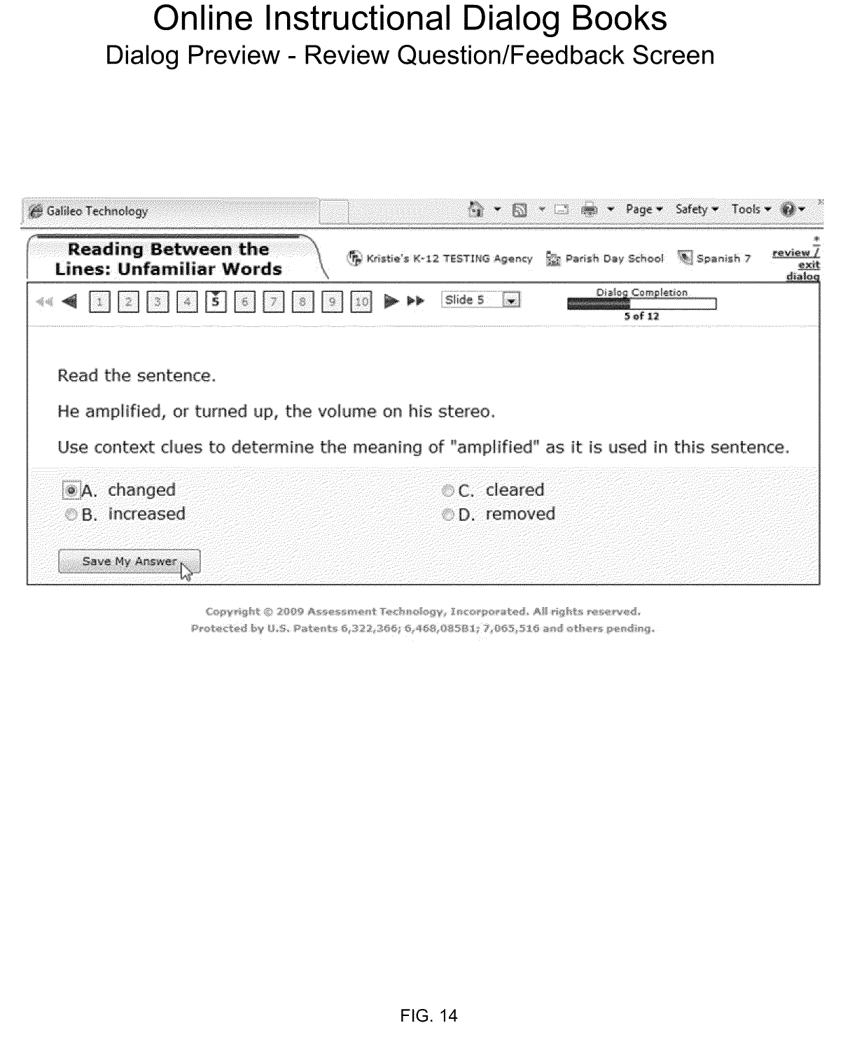

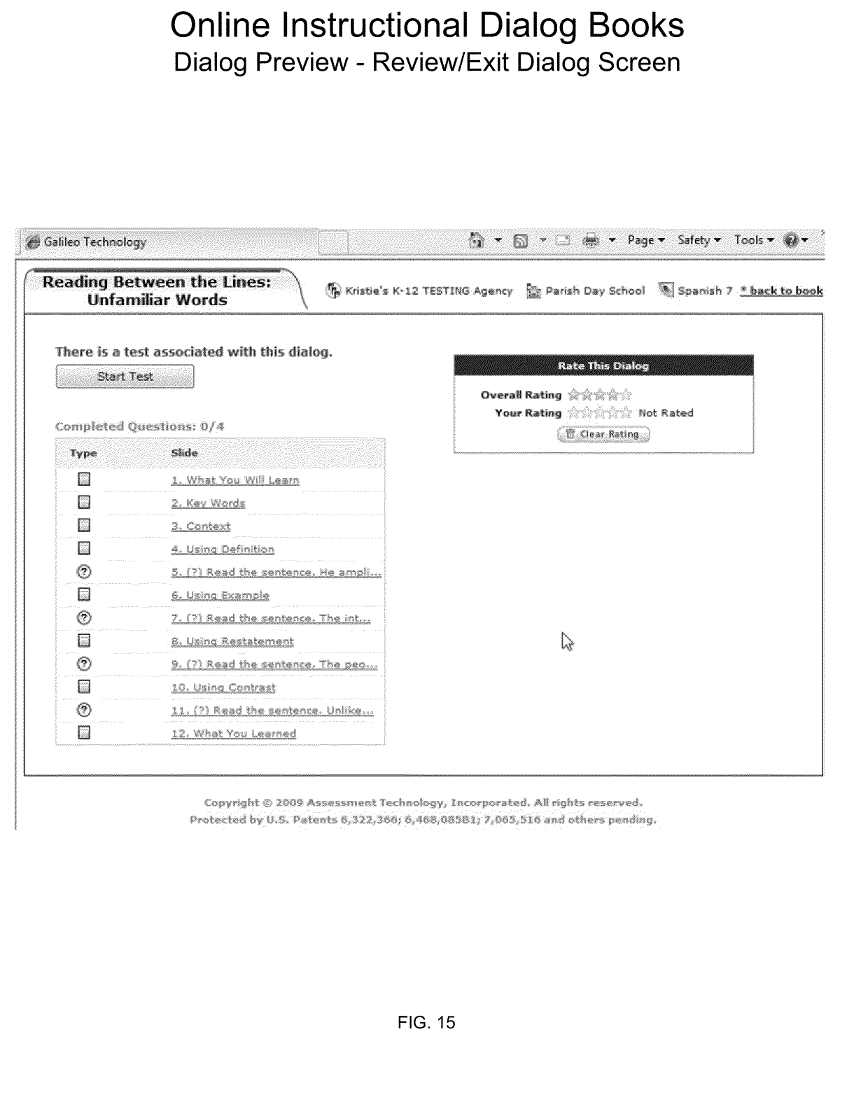

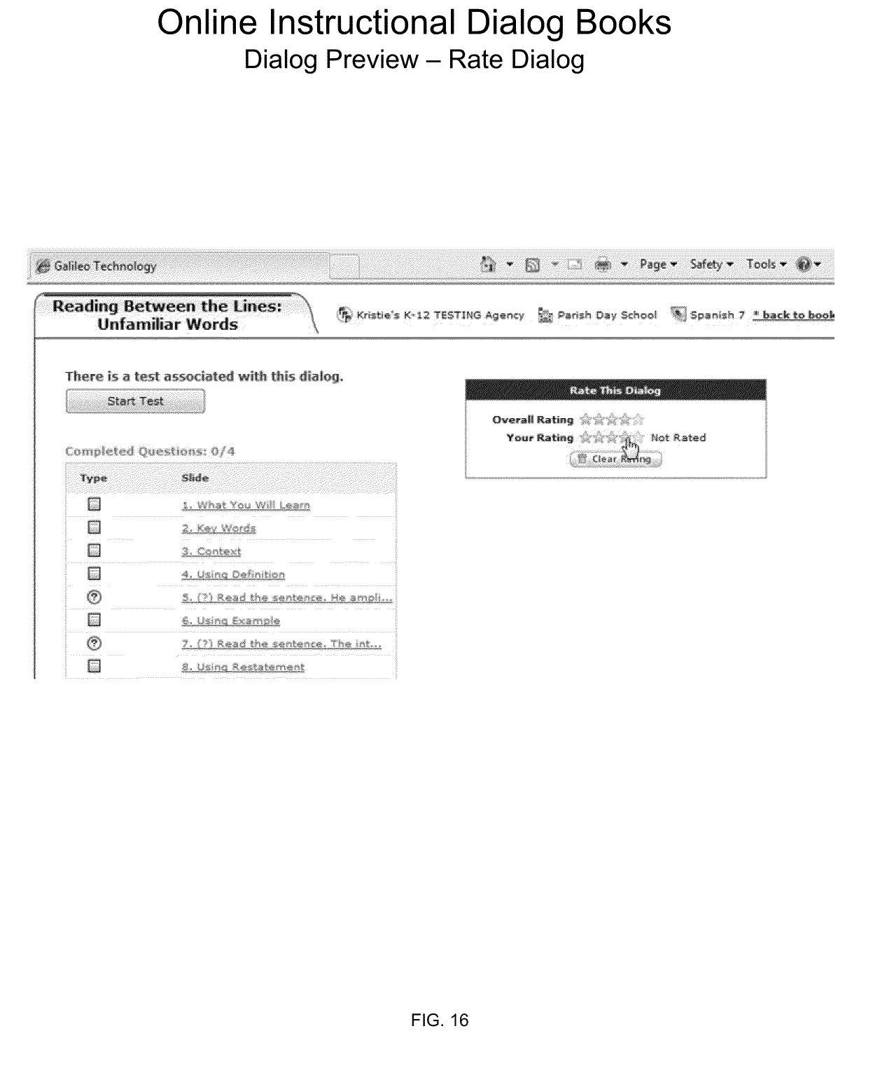

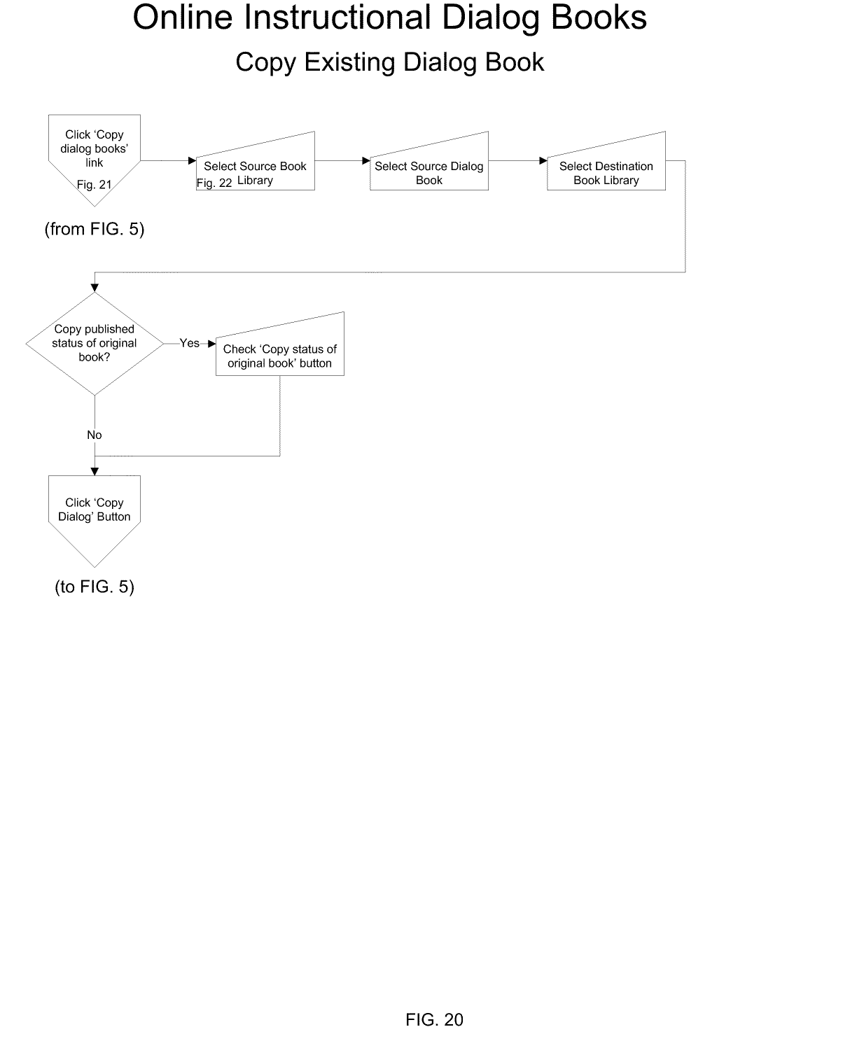

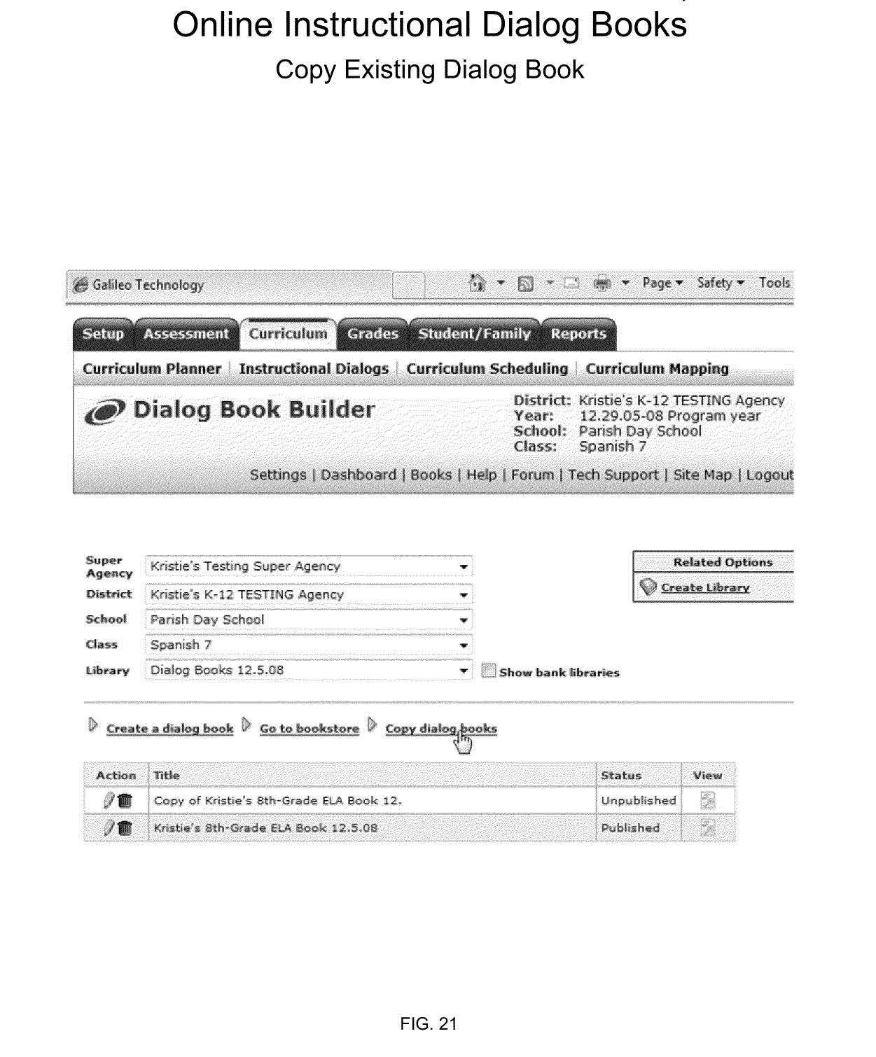

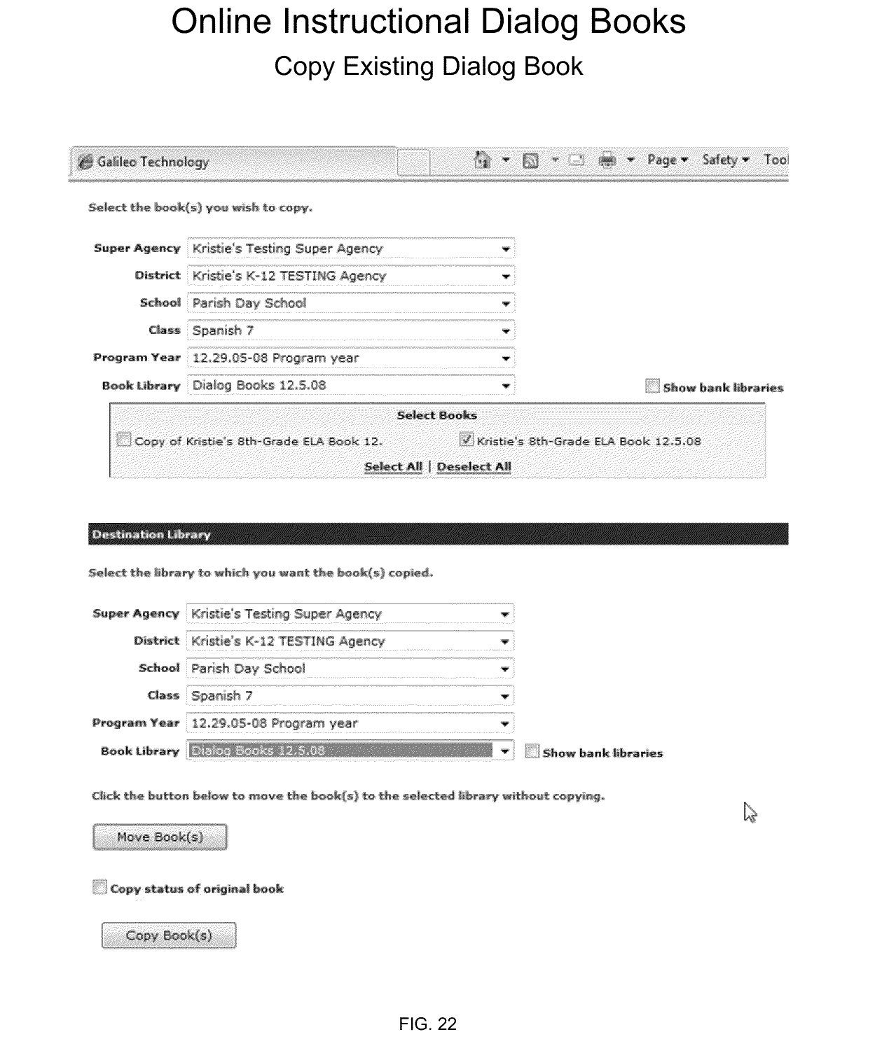

A Book is made available for use by selecting it from the Dialog Book Store (FIG. 8). A book is selected by copying it to a user library (FIG. 20). User libraries provide access to books in accordance with library permissions. For example, a book may be made available to all fourth-grade teachers in a given school. Likewise a book may be made available to a selected group of teachers. Because the selected book is a copy, it may be edited by the user without changing the original book. The copy is linked permanently to the original, which makes it possible to track changes in the book as well as implementations of the book by different teachers with different students.

Of course books may be assigned to students as well as teachers. Administrators may assign a dialog book to groups of students. Likewise, teachers may assign dialog books to the students in their classes. Students may also select books from the Dialog Book Store. When a book is assigned to a student, the book is immediately available for the student's use in the Student/Parent Center. Assignment makes it possible for students to work ahead or review instructional content that has not yet been designated as a homework or class work assignment with a specific due date.

Scheduling and Presenting Dialogs as Lessons and/or Assignments

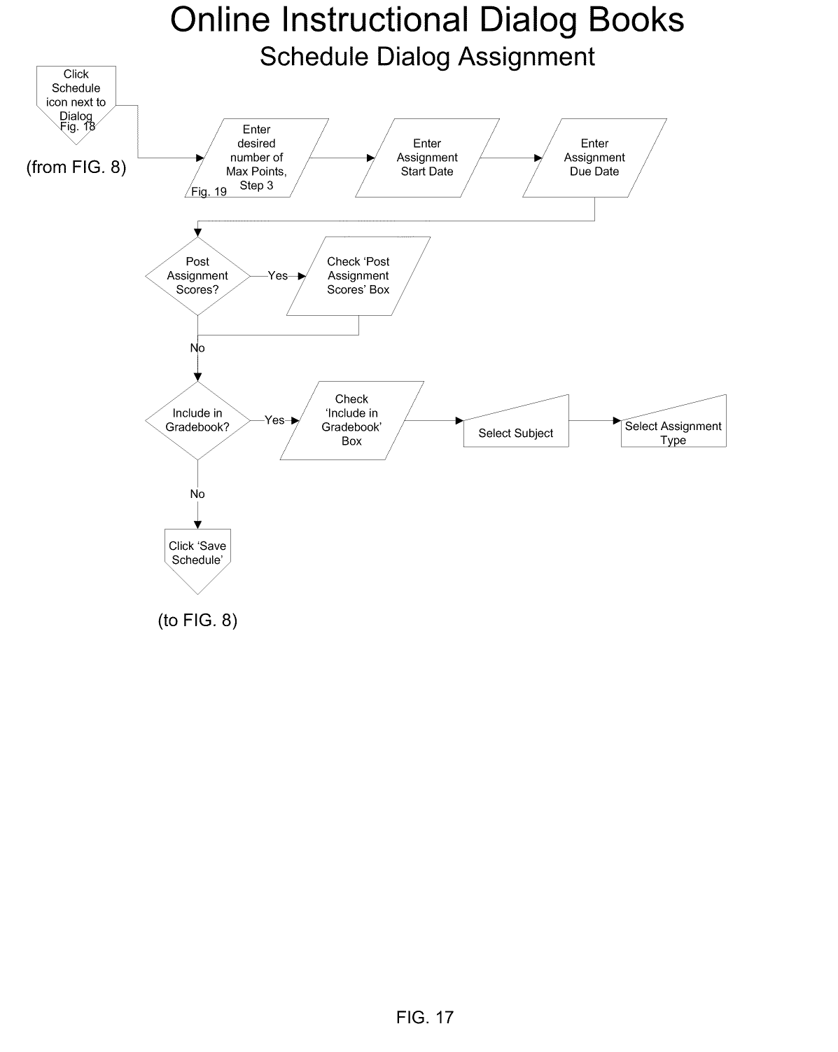

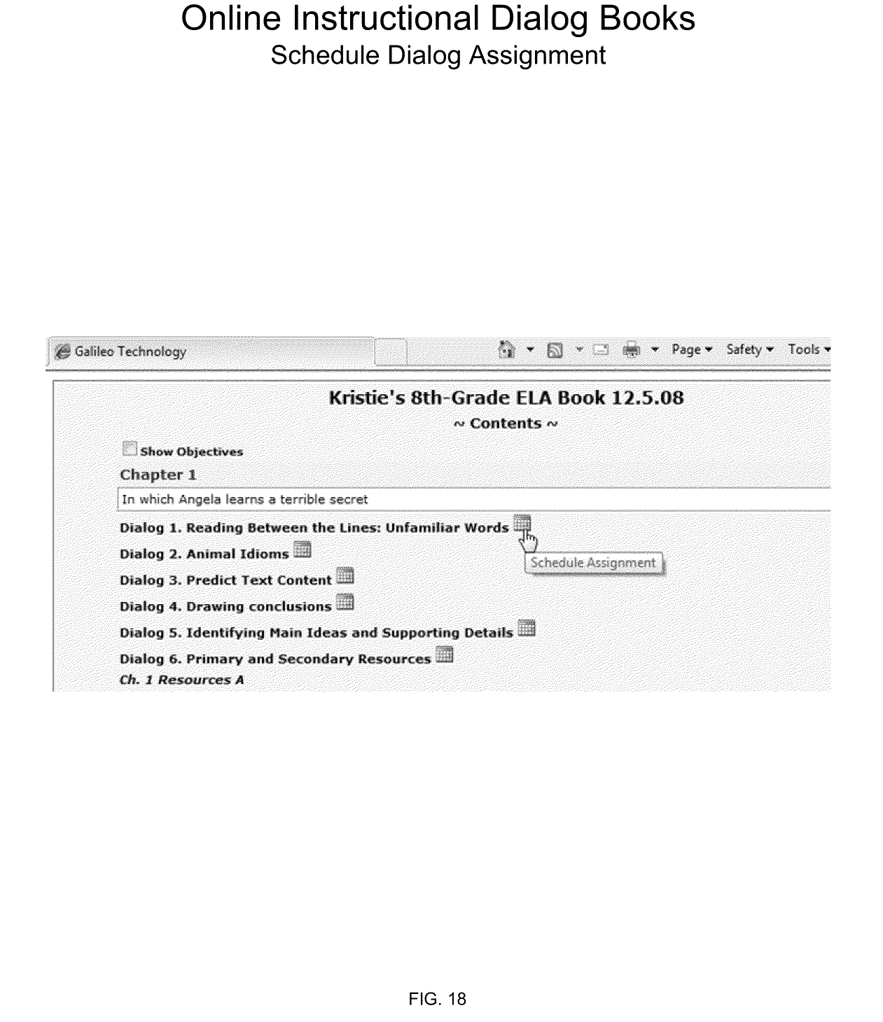

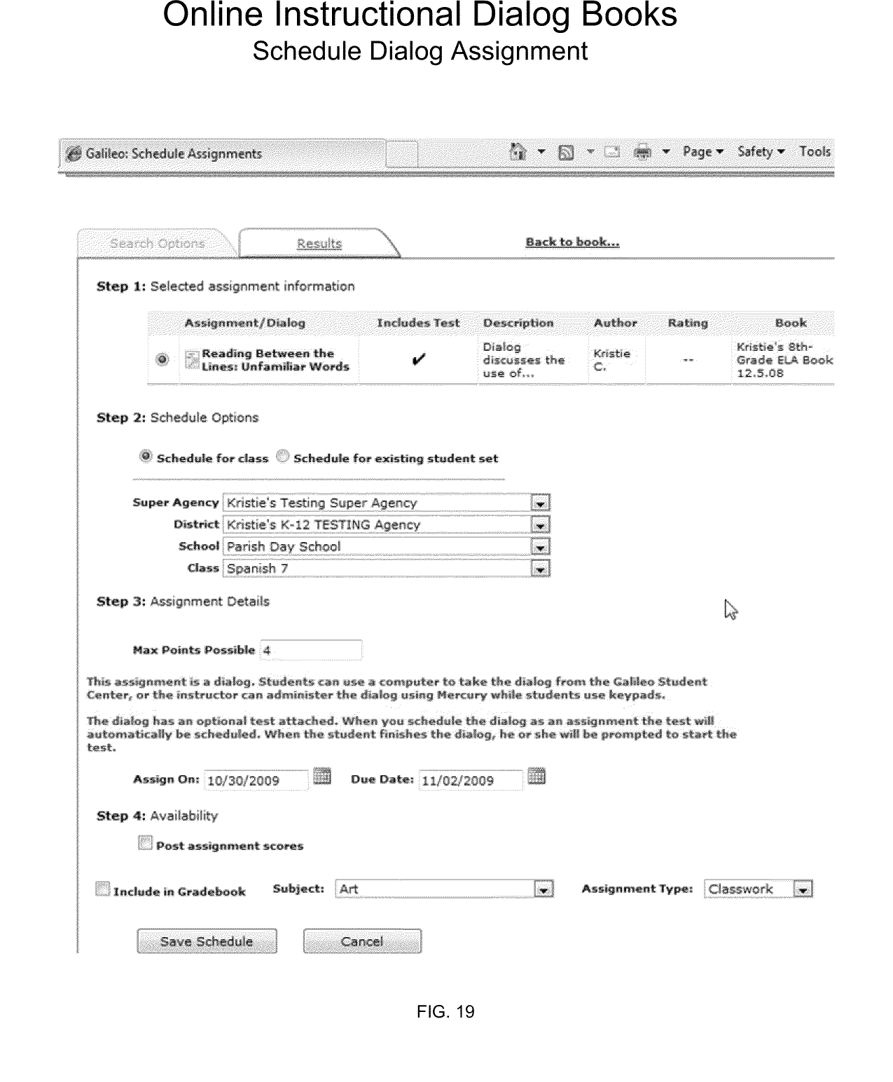

Dialogs including dialogs within a book can be scheduled for implementation (FIG. 17). The schedule indicates the date(s) during which the dialog is presented or available for implementation. The scheduling process is linked where possible to data intended to inform instruction. For example, when a teacher is viewing a report including data indicating that a particular standard be targeted for instruction, the teacher is given the option of scheduling dialogs to address the targeted standard without leaving the screen displaying the report. This scheduling feature facilitates linking the presentation of data intended to inform instruction to immediate instructional action.

Dialogs may be scheduled either as assignments or as lessons or both. A dialog scheduled as a lesson is typically presented in a classroom under the direction of a teacher. When a dialog is presented as a lesson, the teacher controls the presentation of slides presenting the instructional content in the dialog. If the students have access to computers or response pads, they may respond to questions presented in the dialog. Moreover, the teacher may monitor student responses in real time using the Dialog Monitoring tool available in the application. When a dialog is scheduled as an assignment, it becomes available in the Student/Parent Center. The student typically completes the dialog and an associated optional test as an online independent learning activity.

### Assessment Results in Dialog Books

The integration of assessment with instruction is a key component of standards-based education. A major function of assessment in standards-based education is to provide information to guide instruction. In order for this function to be utilized effectively, assessment and instruction capabilities must be integrated. The Intervention Portfolio feature included in dialog book technology provides the needed integration. Intervention portfolios provide teachers and administrators with the tools that they need to make data-driven decisions that can lead to intervention adjustments that promote student learning. The Intervention Portfolio provides three kinds of information for each dialog in a dialog book: The portfolio indicates whether an adequate percentage of students have participated in the dialog. It presents the percentage of students who have met the standard for each objective addressed by the dialog, and it highlights instances in which the percentage of students mastering standards is inadequate.

The Intervention Portfolio enables the user to schedule additional assessments or instruction in instances in which standards mastery and/or dialog participation have not been adequate. To schedule assessments or dialogs, the user checks each standard requiring additional attention. Then the user selects either the assessment or dialog option. The selection brings up the appropriate scheduling interface. The direct link between scheduling and information on student performance and dialog participation allows the user to transform information on performance and participation directly into actions designed to improve learning.

### Intervention Alert Report

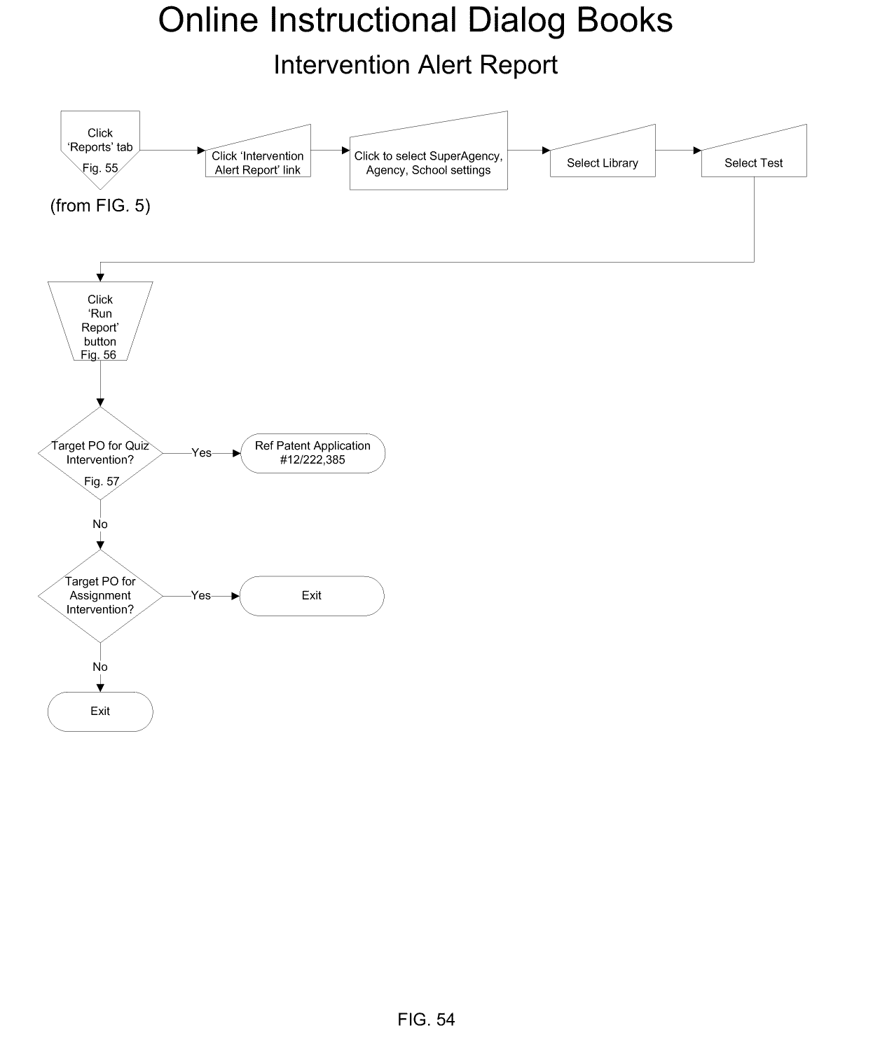

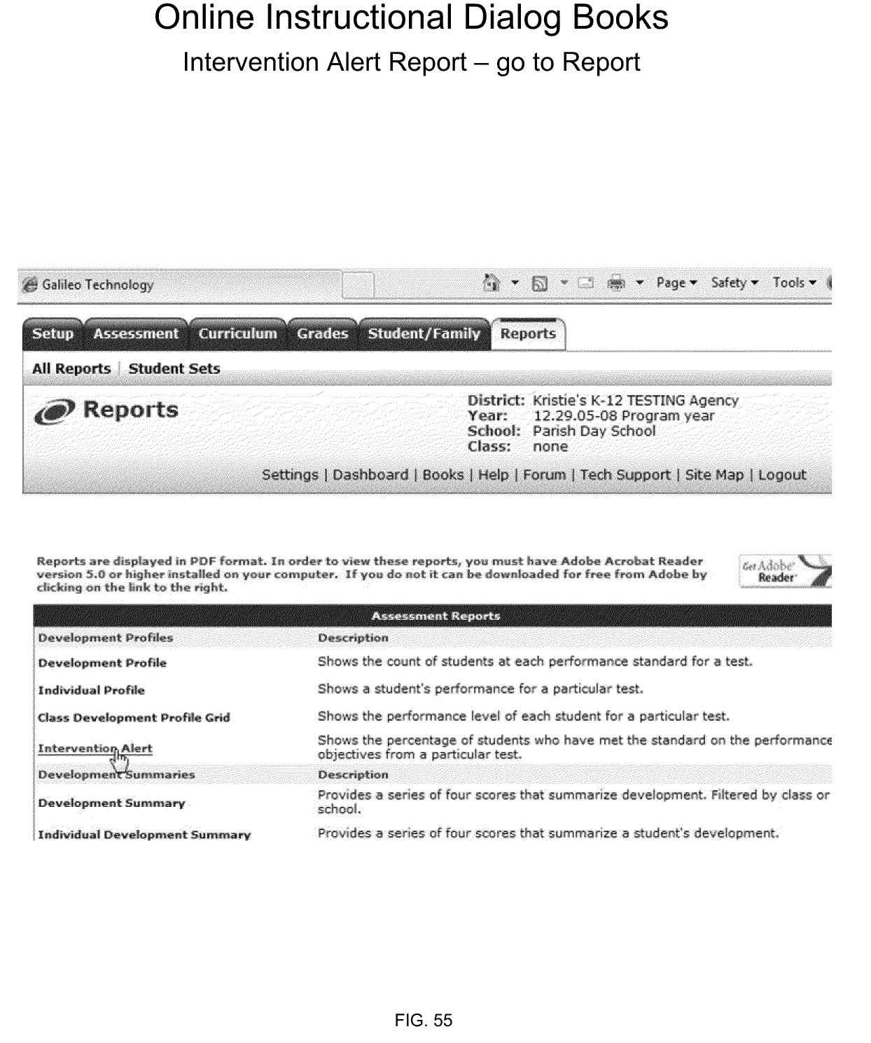

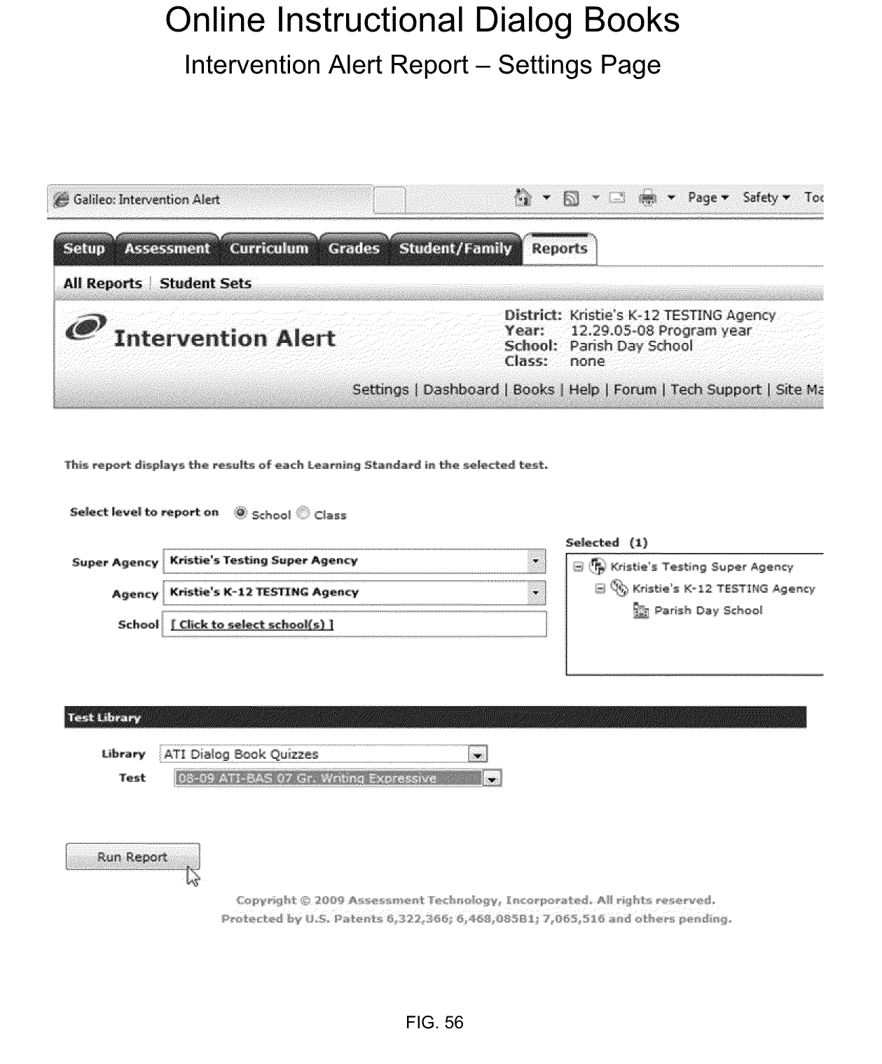

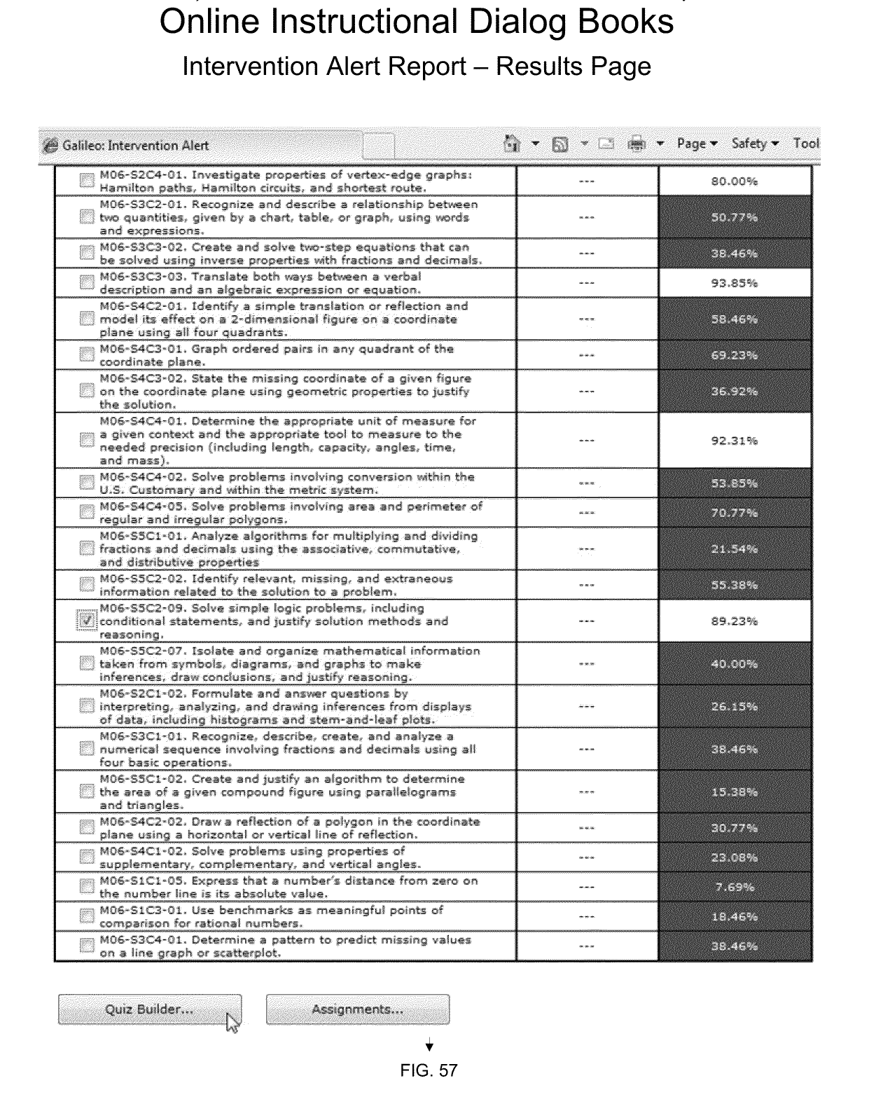

Intervention Alert reporting enables the user to view success on individual tested Performance Objectives when an adequate percent of scheduled students have completed the test (FIG. 54). The Intervention Alert is one of a number of tools that makes a unique contribution to educational management by proactively indicating the need to take action because certain events have occurred. It is different from a to-do list which reminds the user of the need to complete user-defined tasks because it proactively indicates the need for action and because it facilitates the action required.

The Intervention Alert alerts the user (e.g. teacher) to students who have not yet mastered each of a series of standards on a previous assessment. In addition, it indicates which students have not taken the test. The report facilitates direct remedial action by allowing the user to schedule online instructional activities and/or follow-up student assessments for selected standards.

### Computer Hardware and Software

Digital Processor and Associated Memory

As explained above, the invention preferably may be practiced by a digital computing system. By the term digital computing system we mean any system that includes at least one digital processor and associated memory, wherein the digital processor can execute instructions or “code” stored in that memory. (The memory may store data as well.) A digital processor includes but is not limited to a microprocessor, multi-core processor, DSP (digital signal processor), processor array, network processor, etc. A digital processor may be part of a larger device such as a laptop or desktop computer, a PDA, cell phone, iPhone PDA, Blackberry® PDA/phone, palm computer, iPad®, or indeed virtually any electronic device. Multiple digital computing systems may be interconnected or networked together, in a relatively stable or temporary ad hoc arrangements, using any of various well known networking equipment and protocols.

The associated memory, further explained below, may be integrated together with the processor, for example RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such a conventional rotating disk drive. All such memories are “machine readable” in that they are readable by a suitable digital processor as further explained below for the benefit of the US PTO.

### Storage of Computer Programs

As explained above, the present invention preferably is implemented or embodied in computer software (also known as a “computer program” or “code”; we use these terms interchangeably). Programs, or code, are most useful when stored in a digital memory that can be read by a digital processor.¹ We use the term “computer-readable storage medium” (or alternatively, “machine-readable storage medium”) to include all of the foregoing types of memory, as well as new technologies that may arise in the future, as long as they are capable of storing digital information in the nature of a computer program or other data, at least temporarily, in such a manner that the stored information can be “read” by an appropriate digital processor. By the term “computer-readable” we do not intend to limit the phrase to the historical usage of “computer” to imply a complete mainframe, mini-computer, desktop or even laptop computer. Rather, we use the term to mean that the storage medium is readable by a digital processor or any digital computing system. Such media may be any available media that is locally and/or remotely accessible by a computer or processor, and it includes both volatile and non-volatile media, removable and non-removable media. ¹In some cases, for example a simple text document or “flat file,” a digital computing system may be able to “read” the file only in the sense of moving it, copying it, deleting it, emailing it, scanning it for viruses, etc. In other words, the file may not be executable on that particular computing system (although it may be executable on a different processor or computing system or platform.

Moreover, various memory devices may be operatively connected to a processor or server to store computer programs and data. For example, instructional dialogs and instructional dialog books may be considered digital data stored in such devices or systems. Memory systems may be internal to a computer or server, or coupled to it, either locally (e.g., NAS) or “in the cloud” at a remote site. Details of such technologies are known and therefore they need not be presented herein.

### Computer Program Product

Where a program has been stored in a computer-readable storage medium, we may refer to that storage medium as a computer program product. For example, a portable digital storage medium may be used as a convenient means to store and transport (deliver, buy, sell, license) a computer program. This was often done in the past for retail point-of-sale delivery of packaged (“shrink wrapped”) programs. Examples of such storage media include without limitation CD-ROM and the like. Such a CD-ROM, containing a stored computer program, is an example of a computer program product.

It will be obvious to those having skill in the art that many changes may be made to the details of the above-described embodiments without departing from the underlying principles of the invention. The scope of the present invention should, therefore, be determined only by the following claims.

1. A computer-implemented method for building an electronic, interactive instructional content presentation, the method comprising the steps of:
selecting at least one educational resource in the form of a digital file;
importing the selected educational resources into the instructional content presentation;
organizing the imported educational resources in the instructional content presentation into a hierarchical structure for use by educators;
the structure including chapters; and
aligning collections within the hierarchical structure to predetermined educational standards.

2. The method of claim 1 wherein at least one of the educational resources comprises an interactive instructional dialog digital file.

3. The method of claim 2 wherein at least one of the educational resources comprises a predetermined digital media file.

4. The method of claim 3 and further comprising editing at least one of the educational resources in the instructional content presentation so as to adapt the content of the educational resource to the specific needs of a user.

5. The computer-implemented method of claim 1 including storing the interactive instructional content presentation in a digital library so as to enable sharing of the presentation among a group of classes, teachers, schools or school districts.

6. A computer-implemented instructional method comprising:
providing a digital electronic instructional dialog for interactive use by a student;
providing a digital electronic test within or associated with the instructional dialog for interactive use by a student after completing the instructional dialog, the test designed to assess the student's understanding of the subject matter of the associated instructional dialog;
providing user-selected or created feedback to the student, following response to test questions when the test is embedded within the instructional dialog;
linking the test to the associated instructional dialog, so as to automatically prompt a student user to take the linked test after the student completes the associated instructional dialog; and
automatically evaluating results of the test.

7. The computer-implemented instructional method of claim 6 and further comprising:
aggregating the test results over a selected plurality of students; and
exporting the aggregated test results for use in creating a supplemental content presentation corresponding to the associated instructional dialog.

8. The computer-implemented instructional method of claim 7 and further comprising: creating a supplemental content presentation corresponding to the associated instructional dialog and responsive to the aggregated test results.

9. The computer-implemented instructional method of claim 6 and further comprising:
linking the supplemental content presentation to the associated instructional dialog; and
storing the electronic instructional dialog, the associated test, and the supplemental content presentation in association with one another in a digital library.

10. The computer-implemented instructional method of claim 6 and further comprising:
linking the instructional dialog to item specifications providing a description of defining characteristics of items pertinent to the instructional dialog; and
mapping the test associated with the instructional dialog to the item specifications so that the test results reflect student performance relative to the item specifications.

11. The computer-implemented instructional method of claim 10 and further comprising:
defining a correspondence or mapping between the item specifications and prescribed student achievement standards.

12. The computer-implemented instructional method of claim 11 and further wherein the student achievement standards are promulgated by a local school district, state or federal government entity, or Common Core State Standards.

13. A computer-implemented method comprising the steps of:
providing a server computer equipped for remote access by a user;
providing a datastore accessible to the server computer, including storage for a digital library of educational resources including interactive instructional dialog files;
at the server, establishing a login and permissions for a user to use the server computer;
receiving from a user input that identifies a selected school district, school, class and program year;
providing an interactive graphical user interface enabling the user to access curriculum tools for the identified school district, school, class and program year; and
wherein the interface enables an authorized user to view, copy, or edit an existing dialog book stored in the digital library, the dialog book comprising a collection of educational resource digital content.

14. The method of claim 13 wherein the user interface further enables the user to create a new interactive instructional dialog book and store the new dialog book as one or more digital files in the digital library.

15. The method of claim 14 wherein the user interface further enables the user, in connection with creation of a new dialog book, to:
select resource files from the digital library for inclusion in the dialog book;
organize the selected educational resources into chapters; and
align the chapters to predetermined educational standards.

16. The method of claim 14 and further comprising publishing the new dialog book for use by others who have access to the server computer.

17. The method of claim 14 and further comprising:
providing a digital electronic test within or associated with an instructional dialog in the dialog book for interactive use by a student after completing the instructional dialog, the test designed to assess the student's understanding of the subject matter of the associated instructional dialog; and
linking the test to the associated instructional dialog, so as to automatically prompt a student user to take the linked test after the student completes the associated instructional dialog.

18. The method of claim 14 and further comprising:
identifying a local school district, state or federal government student achievement standard;
identifying predetermined item specifications that substantially correspond to the standard;
querying the digital library for selecting pre-existing instructional dialogs from the digital library that are indicated as aligned to the identified item specifications; and
importing the selected instructional dialogs into a dialog book, thereby quickly and easily creating a dialog book aligned to the student achievement standard.

19. The method of claim 14 and further wherein the interactive instructional dialog book stored as one or more digital files in the digital library comprises:
a title and an ordered series of at least two chapters; and
wherein each chapter in the series includes a corresponding chapter title and corresponding chapter performance objective.

20. The method of claim 14 and further comprising:
receiving a rating of an interactive instructional dialog from a reviewer via the interactive graphical user interface;
storing the rating in association with the corresponding instructional dialog in the datastore accessible to the server computer;
receiving an additional rating of the corresponding instructional dialog from a different reviewer;
storing the additional rating in association with the corresponding instructional dialog in the datastore accessible to the server computer;
at the server, aggregating the stored ratings of the corresponding instructional dialog; and
displaying the aggregated reviewer ratings in association with the corresponding instructional dialog to other users of the computer server, so as to share the ratings among interested users including teachers and administrators in schools, school districts or states other than the entity where the corresponding instructional dialog was created.
